(19) United States
(12) Patent Application Publication
(10) Pub. No.: US 2007/0030137 A1
(43) Pub. Date: Feb. 8, 2007

(54) System and method for providing a vehicle display

(75) Inventors: Stephen C. Masters, El Paso, TX (US); Ingolf Gerber, El Paso, TX (US); Douglas B. Waits, El Paso, TX (US)

Correspondence Address: FITCH EVEN TABIN AND FLANNERY, 120 SOUTH LA SALLE STREET, SUITE 1600, CHICAGO, IL, 60603-3406, US

(73) Assignee: Autotronic Controls Corporation

(21) Appl. No.: 11/503,602

(22) Filed: Aug. 14, 2006

Related U.S. Application Data
(63) Continuation of application No. 11/040,897, filed on Jan. 21, 2005, now Pat. No. 7,113,077.

(51) Int. Cl. B60Q 1/00

(52) U.S. Cl. 340/461

(57) ABSTRACT

Information indicating a quantity to be displayed is received. A light pointer is activated based upon the information received. The light pointer is rotated with sufficient speed to generate an arc of light of a predetermined arcuate length to indicate a level of the quantity to be displayed.

### CROSS REFERENCES TO RELATED APPLICATION

This is a Continuation-in-Part, of prior application Ser. No. 11/040,897, filed on Jan. 21, 2005 by inventors Stephen C. Masters et al., entitled A System and Method for Providing a Display Utilizing a Fast Photon Indicator, which is hereby incorporated herein by reference in its entirety.

### FIELD OF THE INVENTION

The invention relates to providing displays in vehicles. More specifically, it relates to providing gauges in vehicles that display information in a convenient and effective manner.

### BACKGROUND OF THE INVENTION

Gauges in vehicles often employ small motors to move a mechanical pointer (e.g., a needle) in order to present various types of information to the drivers of these vehicles. For example, tachometers are used to provide revolution-per-minute (RPM) information and fuel gauges are used to present fuel level information to users. The gauges may employ various types of motors to move the pointers. For instance, cross-coil and stepper motors are sometimes used in tachometers to drive the pointers.

Unfortunately, these previous systems suffered from several shortcomings and disadvantages. For instance, in some previous systems, the pointer had a limited rotation angle due to the type of motor used. As a result of the limited rotation angle, it was difficult or impossible for the gauge to effectively display the full range of values to drivers.

Another limitation of previous systems was that the pointer often had a nonlinear position movement in relation to the input voltage (representing the value to be displayed). In other words, as the input voltage changed, the movement of the pointer did not directly vary in proportion to the voltage change. Consequently, the displayed measurement value could be in error. Although some previous systems attempted to use lookup tables or various hardware circuits to correct for non-linear pointer movement, these attempts were expensive to implement, and were often unsuccessful.

In addition, even with the use of correction tables and additional hardware, previous systems were still extremely limited in the resolution of the display quantities they provided to users. For instance, previous tachometers typically could not indicate an accurate value for RPM better than plus or minus one and one-half percent of the correct value across the full tachometer RPM range. This equated to an over 180 RPM error at a 12,000-RPM full scale reading. Also, since this error was not constant and was much larger at the extreme ends of the pointer's rotation, the lowest and highest RPM values typically had the most display error. The lack of accuracy was particularly disadvantageous in applications such as high-speed drag racing where information having great accuracy and precision is needed by the driver.

Still another shortcoming of conventional pointer gauges was that the motors used in the gauges often lacked the acceleration capability to rapidly swing the pointer so that movement of the pointer did not greatly lag behind the receipt of the actual measurement values. In fact, many gauges had intentionally limited position acceleration rates to avoid this problem.

Being able to adequately view the pointer is also a concern for vehicle drivers since vehicles are often operated in dark, foggy, or otherwise non-optimal conditions. In some previous systems, a constant light source was used to illuminate the mechanical pointer. For example, in some previous systems, several light sources were embedded in a translucent material to conduct light to the center pointer shaft, which caused light to reflect along the pointer. In other previous systems, rotating springs were connected to the pointer shaft to apply a power input to the pointer, which contained an embedded light source. Still other systems used a translucent material to mount both the light source and the drive circuit, thereby illuminating the faceplate and pointer. In yet other systems, multiple LEDs were used to backlight a tachometer or other gauge, which also illuminated the pointer.

Unfortunately, the arrangements used in these systems for providing and maintaining the light source were complex and difficult and/or costly to construct and maintain. Moreover, in all of the above-mentioned previous systems, the light source was used only to illuminate the pointer and did not provide any actual information to the driver.

Still other previous approaches eliminated or supplemented the pointer with multiple rows of stationary LEDs positioned behind the control panel of the vehicle and selectively illuminated these rows of stationary LEDs to present a display quantity. When the stationary LEDs were activated, a bar pattern was presented to the driver, with the number of stationary LEDs activated indicative of the magnitude of the display quantity. Unfortunately, these types of arrangements were limited in accuracy and resolution because only a limited number of stationary LEDs could be positioned in a given amount of space. Also, since these arrangements displayed a bar pattern, they proved unfamiliar and undesirable to many drivers who appreciated the appearance and layout of conventional gauges.

In some applications, for instance, in high speed drag racing, the driver of the vehicle is also concerned with multiple engine or vehicle parameters. For instance, the driver may need to know engine acceleration, fuel pressure and engine temperature in order to effectively control the vehicle and win the race. Previous systems often employed multiple gauges in order to display multiple types of information. Unfortunately, the use of multiple gauges on the engine panel made it extremely difficult for the driver to simultaneously analyze the information and take corrective actions to alter the vehicle performance. For example, in drag racing applications, where races are won or lost by margins measured in fractions of a second, the delay caused by the viewing of multiple gauges could potentially and often did cause the driver to lose the race. In addition, multiple gauges were expensive for vehicle operators to purchase and time-consuming to install and maintain.

### SUMMARY OF THE INVENTION

A light pointer is rotated about a face of a gauge and selectively activated thereby causing one or more arcs of light to be formed on the face of the gauge for presentation to a vehicle user. The one or more arcs of light provide information such as engine RPM, fuel pressure, fuel level, or engine temperature. Once the one or more arcs are displayed, the user can quickly analyze the information provided by the arcs and take any appropriate action to alter the operation of the vehicle. Advantageously, the arcs of light are displayed with a high degree of accuracy and resolution thereby allowing the user to make accurate decisions concerning the operation of the vehicle. Additionally, the movement of the arcs of light is linear in nature (relative to the input voltage representing values to be displayed) and, consequently, corrections or compensations are not needed, thereby enhancing gauge performance.

The gauge can also accept non-linear inputs and using three-point interpolation techniques can be programmed for a linear arc display. In addition, the gauge can be programmed to display a single type of information that is split into multiple (e.g., 4) portions (i.e., separate arcs). For instance, this approach can be taken with thermistor-type temperature sender inputs that present temperature data in a non-linear format.

Furthermore, multiple arcs can be displayed on the same gauge making it convenient for the user to simultaneously view and analyze multiple types of information. Additionally, by using various programming tools, the display quantities (e.g., size, color, intensity) of the one or more light arcs can be conveniently adjusted to suit the preferences and needs of the user. Furthermore, other types of information can be displayed on the gauge face along with the arcs of light such as light dots that, for example, indicate peak display values. In other examples, special LEDs or other indicating mechanisms can be deployed on the face to indicate high and low alarms to the user such as flashing only a portion of the arc for an alarm indication.

In many of these embodiments, a light pointer is rotated at a high rate of speed, for example, from 4000 to 6000 RPM. In this regard, the light pointer may be rotated in a 360 degree circular movement. In other examples, the light pointer may be rotated in non-circular movements such as a 180 degree, semi-circular, back-and-forth movement. Other examples of pointer movements are possible. The high rate of movement of the pointer ensures that, if the viewer chooses, the arc is presented as a non-flickering solid light element. In one example, at 5000 RPM, the time of one LED revolution is 12 milliseconds or 83.3 Hz and no flicker will be apparent to the human eye.

As mentioned, multiple arcs can be displayed on the same gauge. Since the driver can see all arcs simultaneously in one view, they can easily ascertain multiple pieces of information, analyze this information, and adjust the performance of a vehicle as needed in a timely manner. The one or more arcs can be displayed in many different colors, intensity levels, thicknesses, or formats. In addition, the one or more arcs may programmed to be solid, flickering, or some combination of these types. Furthermore, the one or more arcs can be displayed concentrically on the gauge. One or more light sources can be used to form the arcs.

The present approaches also allow the user to program parameters of the gauge in a variety of different ways. For example, a touch switch may be used to selectively reset the peak displayed quantity (e.g., peak RPM), and program other parameters affecting many different gauge characteristics.

In other examples, a personal computer or similar device may be connected to the gauge via a high speed communication bus and the personal computer can be used to program different parameters in the gauge. These parameters may relate to how information is displayed on the gauge or how this information is processed. In one example, the ability to program and adjust configuration information in the gauge allows the gauge to be used in a number of different applications, present different custom displays to users having different display preferences, and allows the gauge to be used to present different types of information to users.

The present approaches also allow for a variety of different measuring devices and other electronic devices to be connected to the gauge. In this regard, a communication bus may be provided that connects the gauge to various other instruments. For instance, and as already mentioned, a personal computer or other interface device may be connected to the gauge and used to configure the gauge. In other examples, other engine controllers may be connected to the bus. These other engine controllers may control or relate to various types of engine functions. Since the gauge can now access information provided by these other instruments, the information can be processed, displayed, or shared with other instruments connected to the gauge.

In another example, the gauge can be connected to a wide-variety of analog sensing devices (e.g., temperature measurement devices, pressure measurement devices) and the information from the devices can be displayed by the gauge. Advantageously, the gauge may be provided with adequate processing ability to receive information in any engineering unit (e.g., pressure, temperature, speed, and acceleration), process the information, and display the information to the driver of the vehicle as one or more arcs of light.

The gauge can be constructed using various approaches. For example, the gauge may include a carrier member that includes a light source. A rotary drive for the carrier member may be operable to shift the carrier member and the light source thereon in a predetermined arcuate path for generating one or more arcs of light. The light source may be a single light source or include multiple light sources, which, in one example, are LEDs.

The gauge may also include a controller and the controller may be programmed to display a vehicle operating characteristic as one or more arcs of light. More specifically, the controller may be programmed to selectively activate and deactivate the light source to create the one or more arcs of light.

The gauge may receive measurement values from different sources (e.g., meters). For instance, the gauge may receive pressure, resistance, current, temperature, speed, distance, and vacuum values from different types of measurement instruments.

The one or more arcs of light can be displayed in different approaches. For instance, the one or more arcs of light can be displayed along a single circumference. In this case, the arcs may be separated from each other along the circumference. In another example, first and second arcs and a second arc may be displayed with a common base point with the first arc growing in a clockwise direction and the second arc growing in a counterclockwise direction from the common base point.

As mentioned, other devices may be coupled to the gauge. For instance, a touch sensitive switch may be coupled to allow for changing display characteristics. In addition, a communication bus may also be coupled to the controller and the communication bus may itself be coupled to a plurality of external electronic devices such as personal computers.

The present approaches also provide a convenient and effective way to program gauges that utilize one or more arcs of light. For instance, a display is provided on a gauge. The display includes at least one light source that presents a level of a vehicle operating characteristic as a length of light displayed according to a predetermined format. A user interface device, such as a personal computer is programmed to adjust the predetermined format of the display. Other user interface devices such as cellular phones, personal digital assistants, and pagers may also be used.

### BRIEF DESCRIPTION OF THE DRAWINGS

FIG. 1 is a block diagram of a system for providing a display of one or more arcs of light according to the present invention;

FIG. 2 is a drawing of a gauge face showing the display of two arcs of light that are slew locked together according to the present invention;

FIG. 3 is a diagram of a GUI interface according to the present invention;

FIG. 4 is schematic diagram of a control circuit for providing one or more arcs of light on a gauge according to the present invention;

FIG. 5 is schematic diagram of a motor interface circuit for providing one or more arcs of light on a gauge according to the present invention;

FIG. 6 is schematic diagram of a motor interface circuit for providing one or more arcs of light on a gauge according to the present invention;

FIG. 7 is schematic diagram of a control circuit for providing one or more arcs of light on a gauge according to the present invention;

FIG. 8 is schematic diagram of a control circuit for providing or more arcs of light on a gauge according to the present invention;

FIG. 9 is schematic diagram of a light pointer circuit for providing one or more arcs of light on a gauge according to the present invention;

FIG. 10 is schematic diagram of a control circuit for providing one or more arcs of light on a gauge according to the present invention;

FIG. 11 is a flowchart of data flow through the gauge according to the present invention;

FIG. 12 is a flowchart of the main routine used by the controller to generate one or more arcs of light according to the present invention;

FIG. 13 is a flowchart of the ArcTimeList routine (of FIG. 12) according to the present invention;

FIG. 14 is a example of using the TimeList output (of FIG. 13) to present multiple arcs of light on a gauge according to the present invention;

FIG. 15 is an example of a configuration file according to the present invention;

FIG. 16a is a front view a gauge assembly according to principles of the present invention;

FIG. 16b is a side, cut-way view a gauge assembly according to principles of the present invention;

FIG. 16c is another front view a gauge assembly according to principles of the present invention;

FIG. 16d is another side, cut-away view a gauge assembly according to principles of the present invention;

FIG. 16e is an exploded view of the light pointer assembly used in a gauge assembly according to principles of the present invention;

FIG. 16f is an exploded view of another example of the light pointer assembly used in a gauge assembly according to principles of the present invention; and

FIG. 16g is a perspective view of examples of primary and secondary bobbins according to principles of the present invention.

### DETAILED DESCRIPTION OF THE PREFERRED EMBODIMENTS

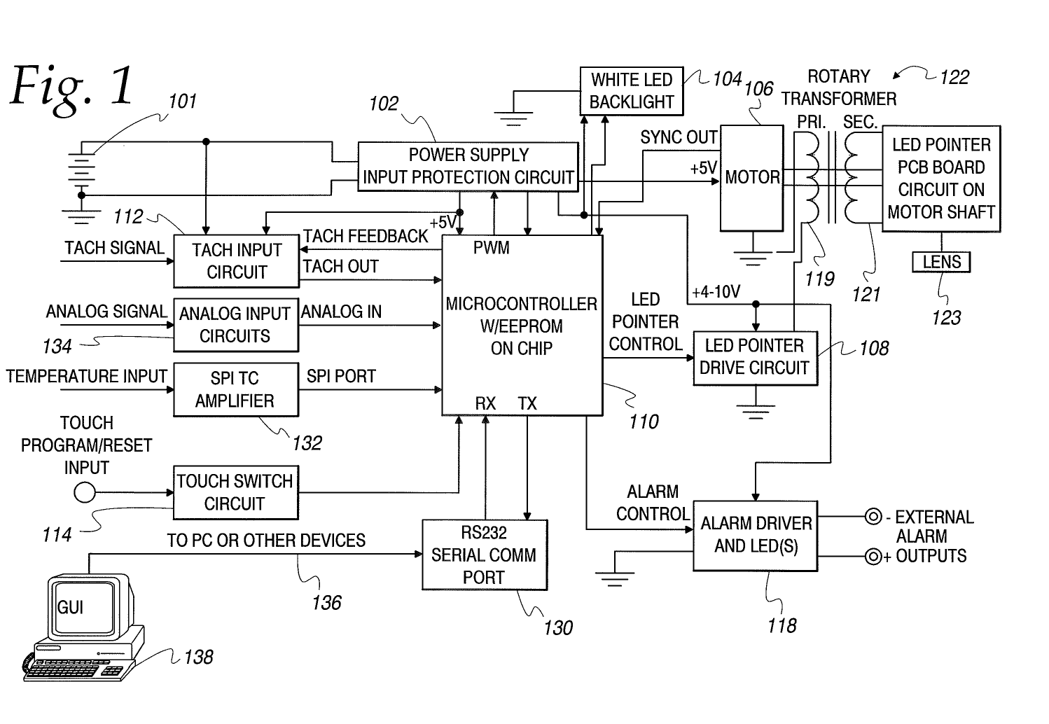

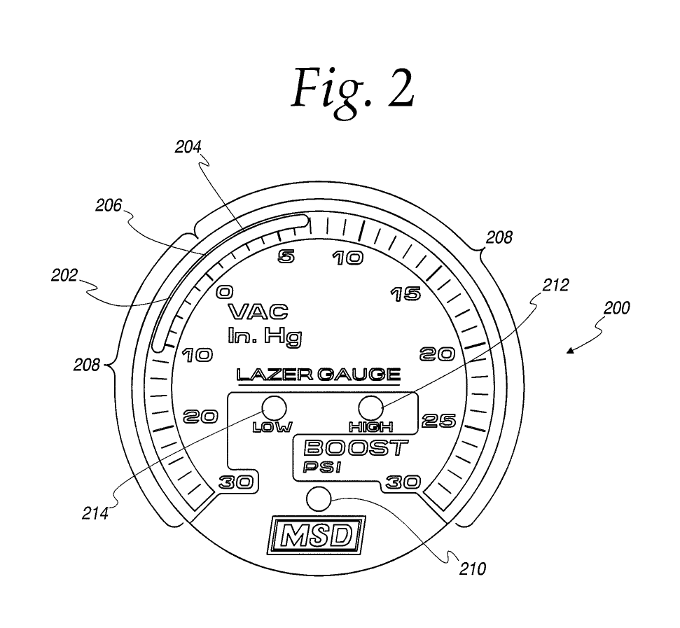

Referring now to FIG. 1, one example of a gauge that displays one or more arcs of light is described. In one example, the gauge may be a tachometer and display engine RPM data as an arc of light. In another example, the gauge may display two arcs of light with one arc representing RPM information and the other arc representing engine temperature information. In still another example, the gauge may display RPM, pressure, temperature, and fuel level information as four arcs of light. It will be understood that these are examples only and that the gauge may display any type or types of information relating to vehicle performance as any number of arcs of light.

A power supply circuit 102 supplies power to a motor 106. The motor 106 drives and rotates a light pointer 120. As described in greater detail herein, a microcontroller 110 (including an EEPROM), after receiving various inputs from different sensors or measurement devices, drives a light pointer drive circuit 108, which, in turn, regulates the voltage across a rotary transformer 122. The voltage regulation of the transformer 122 activates and deactivates the light pointer 120 as it rotates to create one or more arcs of light that are presented to the user on the face of a display, in this example, a graduated lens 123. In one approach, the length of the arc or arcs represents the quantity or level of the information that is to be displayed. Other information such as peak measurement values can also be displayed on the gauge by the light pointer 120. In this example, this information may be displayed as dots or points of light.

Although the lens 123 is preferably graduated, the lens may be ungraduated as well. Additionally, the lens may be constructed of any suitable material such as plastic or glass. The thickness of the lens may also vary, but in one example, the lens is a 0.125 inch polycarbonate lens.

An alarm drive and LED circuit 118 may also be used to display information relating to alarms to the user such as when the RPM is exceeding a threshold value. In this regard, the alarm drive and LED circuit 118 may provide LEDs or other indicating devices to indicate alarms to a user. For instance, the reaching of low and high alarm values (indicating when an alarm should be reported to the user) can be indicated by flashing or otherwise activating separate red LEDs presented on the gauge.

Display information and/or programming information (as to how to present the display information on the gauge face) are received by the gauge in various formats, voltages, currents, and from various sources via a touch switch circuit 114, an input circuit and comparator 112, analog input circuits 134, a temperature amplifier 132, and a communication port 130.

The communication port 130, which in one example is an RS-232 compliant communication port, receives information via a communication bus 136 from a personal computer 138. This information may be in the form of configuration commands received at the computer using a graphical user interface (GUI). The GUI support software can be executed on a personal computer running, for example, Microsoft Windows. The GUI can be used in the factory during manufacturing for calibration or other programming purposes. In another example, the gauge user can utilize the GUI to edit certain selected values such as LED intensity range and the type of alarms to be displayed.

Other devices such as engine controllers may also be coupled to the controller 110 via the communication bus 136. For instance, the gauge can exchange information with the other engine controllers via the communication bus 136.

In some vehicular applications, the communication bus 136 can be connected to an external, centralized engine control box as well as other gauges. In this approach, the engine control box can broadcast messages to all gauges at the same time and each gauge can use only the information it needs from the received broadcast message.

The user may also program information into the gauge by pressing one or more buttons or touch switches. In this regard, the touch switch circuit 114 (including a button or touch switch) receives commands that may reset display parameters. For instance, the touch switch 114 can be used to set alarm values for the gauge that are to be displayed. The touch switch circuit 114 can additionally be used to select among features such as cylinder count, sensor calibration for fuel tank senders, program low and high alarms, reset peak value displays, calibrate distance traveled, select DEMO speeds, and reset the gauge with default configuration values. Shiftlight values can also be programmed to show an RPM value as an arc of light.

Analog signals from analog measurement devices are received at the analog input circuits 134. For example, information from pressure gauges may be received at the analog input circuits 134. In this example, the gauge is capable of measuring analog signal values from any type of sender circuit, and the signals may be converted into any engineering unit desired. For instance, a sender of fuel level information may be a variable resistor (e.g., the signal is a current divider type input) and the information may most accurately be displayed in units of ohms. In one example, the range is 0 to 240 ohms or less representing full to empty or empty to full. In other gauges, such as oil pressure gauges, the gauge can accept either a current divider input or a voltage signal from a 3-wire pressure sensor.

The temperature amplifier 132 receives temperature information indicative of engine temperature from a temperature sensor. In one example, the temperature amplifier 132 may be a type-K thermocouple amplifier. Additionally, the input circuit and comparator 112 receive engine RPM information from the engine of the vehicle.

Configuration information can be stored in the EEPROM of the microcontroller 110 for converting the received information into any engineering units desired, including pressure, ohms, current, and temperature using thermistor type inputs with accurate linearization over various operating ranges, temperature using thermocouples, speed, distance, and vacuum. Other types of conversions into other types of units may also be performed.

The various types of input information received by the gauge are forwarded to the microcontroller 110, which processes the information so that it can be displayed on the face of the gauge. In this regard and as mentioned, the microcontroller 110 configures the information for display and uses the configured information to control the operation of the light pointer drive circuit 108. In turn, the light pointer drive circuit 108 controls the rotary transformer 122 (which is driven by the motor 106), and, hence, the light pointer 120.

In order to effectively display the information as one or more arcs of light on the face of the gauge, the operation of the motor 106 and microcontroller 110 are synchronized. In this regard, various types of timing information (e.g., synchronization signals) are received by the microcontroller 110 from the motor 106. The timing information is processed by the microprocessor 110 (as described in greater detail below) and the pointer drive circuit 108 is appropriately activated or deactivated.

The microcontroller 110 processes the various signals received by the gauge either as interrupts or by polling. In one example, the microcontroller receives a tach signal interrupt (via the tach output signal from the tach input circuit 112) and generates a tach feedback signal for controlling the tach interrupt input. The microcontroller 110 also receives an interrupt from the communication port 130 whenever data is received over the bus 136 from the personal computer 138 or other devices attached to the bus 136. The microcontroller 110 polls other inputs (e.g., the touch switch circuit 114, analog input circuits 134 and the temperature amplifier 132) so as not to interfere with interrupt servicing. The microcontroller 110 also receives a synch signal interrupt input from the motor that provides motor position and motor speed information.

The light pointer 120 may be an LED pointer, light pipe, or similar arrangement. The pointer 120 includes the light source (e.g., the LED) and any additional circuitry needed to support the light source (e.g., a printed circuit board (PCB)). As mentioned, the pointer drive circuit 108 selectively activates and deactivates the pointer 120 thereby producing one or more arcs of light on the lens 123.

If a light pipe is used, a rotating light pipe and stationary LED are provided. The microcontroller 110 can directly drive the LED positioned under the light pipe and focus the beam of light (using a small lens) on the lens 123. In one approach, using a light pipe eliminates the rotary transformer 122, and the spinning printed circuit board (PCB) with the diodes, LED, resistor, capacitor and the gated oscillator and driver circuits. In addition, using this alternative approach, the stationary LED can be an ultra bright LED of 2,000-mcd. Other components may be eliminated utilizing other approaches.

Referring now to FIG. 2, one example of a gauge face or display that is presented to a user is described. The face 200 includes two arcs of light 202 and 204. Both of the arcs originate at a common point 206. The arc 202 is displayed so as to grow in a counterclockwise direction from the point 206 and the arc 204 is displayed so as to grow in a clockwise direction from the point 206.

The type of quantities displayed as arcs of light are preferably different. For instance, the arc 202 may present pressure information while the arc 204 may present vacuum information. And, as mentioned, since the arcs originate from a common base point 206, they are slew locked together. When the data input is from a common transducer such as a MAP or manifold absolute pressure sensor, it may be desirable to use the slew lock approach since the two displayed data values are in different units (i.e., PSI and vacuum), which allows the user to see both pressure and vacuum displayed relative to each other on a single gauge with a single sensor input.

The arcs 202 and 204 can be solid arcs, flashing arcs, a variable length arcs, different colors, different intensities, or sweeping arcs. Additionally, the arcs 202 and 204 can be overlapping and non-overlapping from the others. The arcs 202 and 204 may be positioned on the same radius from the center of the gauge face or the arcs may be concentrically located (i.e., positioned at different radii) from each other. For instance a first arc may be located at a first circumference (at a first radius from the center of a gauge) and this arc may be inward from a second arc located at a second circumference (i.e., at a second radius where the second radius is greater than the first radius). Other variations and combinations of displaying the arcs of light on the face or display of the gauge are possible. Furthermore, decals 208 can be applied to the face of the gauge and indicate the absolute value of the measurement units of the arcs 202 and 204. In one approach, when the slew lock function is selected, only one of the two arcs may be visible at a given time. For example, with a vacuum/boost gauge, the pressure must drop below zero PSI to display the value of vacuum since vacuum data is actually negative PSI.

Additionally, a touch switch 210 is used by the user to program information into the gauge. A high alarm LED 212 is flashed when one of the arcs 202 or 204 exceeds a certain value and the low alarm LEDs 214 is flashed when one of the arcs 202 or 204 is below a certain value. The alarms may be displayed with discrete LEDs for the high and low alarms or the arcs of light may flash the portion of the arc that is over the alarm value.

Referring once again to FIG. 1, the personal computer 138 is used to program the configuration of the display and provides a GUI to the user. The user interacts with and uses the GUI to make selections from a menu of configuration options. The options may program or display parameters or characteristics of the arcs to be displayed such as arc beginning points, arc ending points, low and high alarm values, time slot selections, gauge types, sensor minimum or maximum values, engineering units, conversion values, decal minimum or maximum values, minimum and maximum intensity values, slew rates, sensor channels, arc sizes, arc directions, software revisions, or cylinder counts. Other examples of parameters can be used and programmed into the gauge.

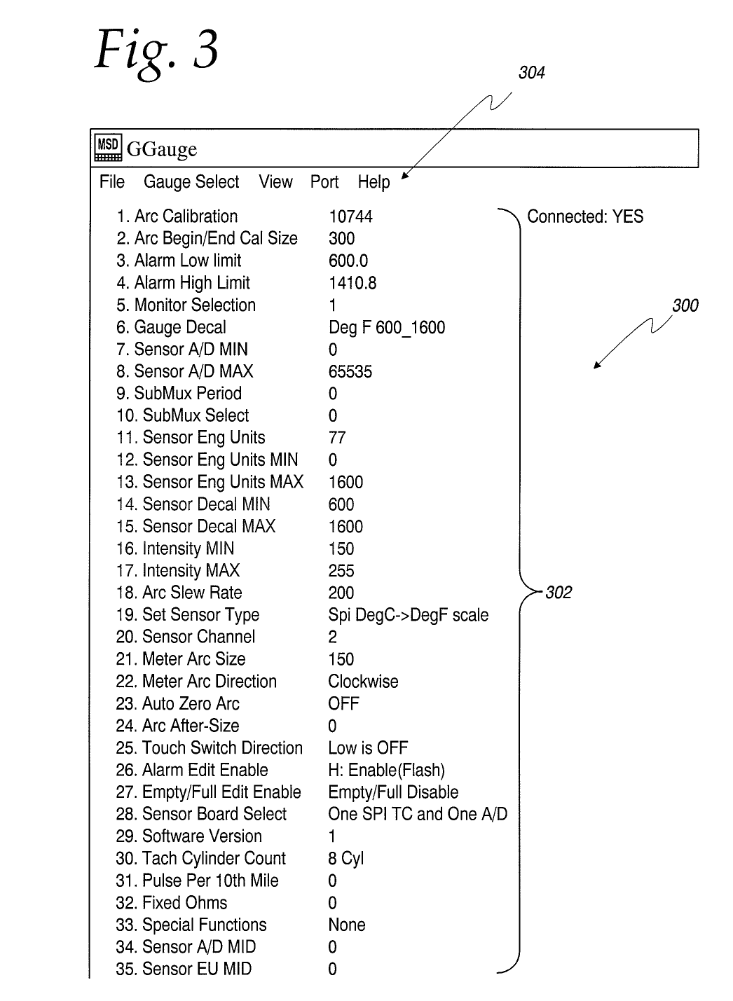

Referring now to FIG. 3, one example of a GUI interface 300 is described. As shown, the GUI interface includes values 302 for 35 gauge parameters. These parameters are discussed in greater detail later in this specification, for instance, in connection with the commands that are used to set the parameters. Various pull down menus 304 allow the user to save or print the file, select other gauges (other arcs of light displaying other quantities), view other parameters, view port information, or receive help information. A command line interface may also be provided for the user to enter various commands to read or write to the stored parameters. Alternatively, the GUI may utilize touch screen approach that allows the user to adjust these parameters. It will be appreciated that FIG. 3 is an example of one GUI and that other GUIs with different appearances and user input mechanisms are possible.

Referring once again to FIG. 1, the speed of the motor 106 is loosely regulated and does not affect the accuracy of the displayed value or the peak displayed value. In one example, the motor speed control is regulated to a maximum voltage of 10 volts. A low cost brushless fan motor can be used for the motor 106 upon which the pointer light pointer 120 and any other supporting circuitry (e.g., rectifying diodes) is affixed.

In the example of FIG. 1, the speed of the motor 106 is measured for each revolution by a device such as an optically slotted switch, an optically reflective photosensor (such as a CNB10010RL sensor manufactured by Panasonic or the SFH9240 sensor from OSRAM, Inc.), or from the brush-less fan motor commutating hall-effect device. Preferably, this synchronizing signal (referred to herein as the sync interrupt signal) is less than 50 degrees in duration to provide for proper interrupt processing by the microcontroller 110 and to allow an RPM indicated range covering an angular range of at least 300 degrees.

In one example, the microcontroller 110 may be a PIC18F1320 microcontroller and will enable any of the gauges to be configured using a single source code file complied for the specific hardware configuration of the gauge. The microcontroller 110 provides a sufficient program memory and RAM that allows the code to be compiled with all functions available and allow setting the gauge configuration for hardware in EEPROM. The microcontroller 110 allows the complete compiled code with total gauge configuration in EEPROM (such as a Microchip part dsPIC30F3012). The microcontroller 110 is also chosen so as to be usable for any gauge type such as for a tachometers, tachometers with boost pressure, dual pressure gauges, single/dual temperature gauges, or speedometers.

The microcontroller 110 receives the sync interrupt signal. This signal may be processed using a voltage comparator to square up the phototransistor signal for faster rise and fall edges which are more precisely processed by the microcontroller 110. The interrupt indicates the beginning of the reset period. At the end of the reset period, the microcontroller 110 begins a display cycle of the one or more arcs of light.

The tachometer input circuit 112 accepts a wide range of input signal amplitudes while providing a precise jitter-free output for the microcontroller 110. A tachometer signal may come from an ignition device source such that it has an amplitude of near zero to positive battery voltage levels, or it could come directly from an ignition coil terminal resulting in a signal with an amplitude near zero volts and as high as 400 volts peak with a ringing waveform due to current limiting High Energy Ignition (HEI) type coil drivers or normal coil primary ring out after the ignition spark has ceased flowing.

The tachometer input signal is preferably de-bounced by the tachometer input circuit 112 using an input R-C filter and adjustable inhibit period which in one approach is calculated to be ¼ of the tachometer input period provided by the microcontroller 110. This action also rejects noise extremely well providing for an enhanced ability to track engine RPM changes.

Power is supplied to the spinning light pointer 120 on the motor shaft from the microcontroller 110 by the use of the rotary high frequency transformer 122. There are several approaches that can be used to supply this power such as using brushes and slip rings, or using a motor with a hollow shaft and mounting the LED stationary and using a light pipe, fiber optic or mirrors to guide the light to the desired location to be viewed.

The transformer 122 may be a small rotary transformer that is constructed of a ferrite bead retained in the motor shaft extension to which the PCB is mounted with the LED, diodes and secondary winding. A primary winding 119 of the transformer 122 is stationary and mounted to the motor frame surrounding a spinning secondary winding 121. The primary 119 of the transformer 122 is driven at about 6 MHz in a preferred approach and induces a current flow in the LED of 15-25 milliamperes. In an alternate approach, a rotary transformer is constructed from a small powered metal core with a size of 0.350 inch outer diameter (O.D.) by 0.135 inner diameter (I.D.) by 0.050 inch thick, making an extremely thin rotary transformer less than 1/10 inch thick and under ½ inch O.D. In this example, the core is available from Magnetics Inc., part number 77030-AY-04.

The pointer driver 108 can use various components to drive the transformer 122. For example, the driver of the primary winding 119 may be a MOSFET driver such as the MC33152P from Motorola, Inc., or could be a discrete transistor bridge driver with push-pull arrangement. For instance, a 6 MHZ oscillator drives the MC33152P, which is gated on/off by the microcontroller, and which is constructed from a MC14093 quad Schmitt-trigger NAND gate IC from ON-Semiconductor. In one example, the transformer 122 is driven at a speed greater than 2 MHz to provide fast turn on of the LEDs on the light pointer and so that the oscillator can be shut down in less than 3 microseconds for the accurate display of RPM information.

The power supply input circuit 102 is coupled to the motor 106 and, in one example, consists of input protection, clamping, reverse polarity protection, filtering and regulation for the various circuit blocks. Since the gauge is preferably capable of withstanding an incorrect battery potential or reverse battery potential, the power supply input circuit 102 advantageously consists of several protection devices to protect the internal circuit from both over voltage and reverse polarity at the power input terminals.

A power supply 101 may supply 10 volts to the motor 106 (via the power supply input circuit 102), and may draw as little as 50 milliamps of current. This power arrangement aids in moving heat from an pointer driver circuit 108 to the housing of the gauge components.

The motor 106 is preferably a small brushless fan motor such as a KDE1204 PFB3-H from SUNON, which measures 40 mm square by 10 mm thick. Other types of motors can be used and/or specifically designed to rotate the light pointer 120.

The rotary transformer 122 is used to convert the microcontroller output signal and drive the light pointer 120 to display one or more arcs of light. This signal is preferably delivered from the stationary drive circuit to a rotating circuit on the motor shaft. In one preferred approach, there is no physical contact between the rotary transformer primary winding 119 and the secondary winding 121. In one example, the primary winding 119 of the rotary transformer 122 is a small coil constructed of 20 turns of 36 gauge magnet wire wound on a thin coil form about ¼ inch inside diameter and measuring about ¼ inch tall. This primary winding 119 is fixed to the motor frame and is stationary. In one example, the rotary transformer secondary winding 121 is wound over the nylon coil form which contains a small ferrite bead (which functions to suppress high frequency noise) such as a EXC-L351350 from Panasonic, and which, in one example, measures 5 mm long by 3.5 mm diameter by 1.3 mm inside diameter. The nylon coil form also provides the mount to the motor shaft and the mount for the light pointer 120.

The light pointer 120 may be a LED printed circuit board that, in one example, contains the 4 rectifying diodes, a 220-pf capacitor, a 36-ohm resistor and a surface mount LED at the tip of the pointer. For instance, the outside diameter of the secondary winding is about 3/16 inch so that there is an air gap of about 1/32 inch between the secondary winding and the primary coil form. Both windings are about ¼ inch tall and overlap one another when assembled. As the primary winding 119 is excited with the 5-6-mhz drive current, a current is induced in the secondary winding 121, which is full wave rectified and applied to one or more LEDs on the light pointer 120 to produce about 15-30 milliamps of forward LED current, enough current to drive these LEDs to produce 100 mcd or more of photon or light output in one example. Since, in this example, the LEDs have a 25-degree focused divergent beam, it appears very bright to the observer's eyes from several feet distance even when viewed in bright daylight.

The light pointer 120 is an isolated circuit that is mounted on the fan motor shaft and is constantly spinning around, in the present example, at approximately 5000 RPM. The light pointer 120 is invisible to the human user except for the arc or arcs of light emitted. The light pointer 120 is only activated (illuminated), for a limited rotation angle corresponding to the one or more arcs of light on the display (e.g., on the lens 123).

The LEDs used on the light pointer 120 may be a surface mount type such as a super red output SSL-LXA228SRC-TR31 from LUMEX, which has an output of 170-mcd at 20 milliamps with a viewing angle of 25 degrees. The use of a blue surface mount LED from LiteOn, LTST-C930CBKT, is available with a 25-degree viewing angle and produces a light output that is very intense, at 180-mcd, but has less fringing or star effect.

The activation of the LEDs of the light pointer 120 can be halted quickly so that the light beam will not appear smeared or a peak RPM dot would be too wide. In this regard, turn-on and turn-off times are preferably less than 2 microseconds.

The present approaches also use one or more white light emitting diodes 104 for back ground illumination. In one example, four light emitting diodes are used and these white LEDs emit about 2500 to 10000 mcd at less than 40 milliamps current draw for an extremely efficient cool light source with an extremely long life compared to tungsten filament type bulbs and are also very immune to vibration that can shorten the life of filament type bulbs. This light is used to illuminate the white tachometer faceplate numerals and marker lines so they can be seen in low light. These white LEDs may be a type such as SL905WCE from Sloan Corporation, which are rated at 1200-mcd at 30 milliamps and provide a 45-degree viewing angle or such as the LW E67C-U1V1-3C5D from Osram, Inc. with a 120-degree viewing angle and up to 2500-mcd outputs. These have a forward voltage drop of about 3.6 volts so they are connected as two series pairs and are connected to the +10.1 volt dc supply. They are biased at about 15-20 milliamps each for sufficient light output. Alternatively, other colors of LEDs may also be used. For instance, red LEDs can be used and illuminated when certain situations (e.g., emergency situations) are detected by the gauge.

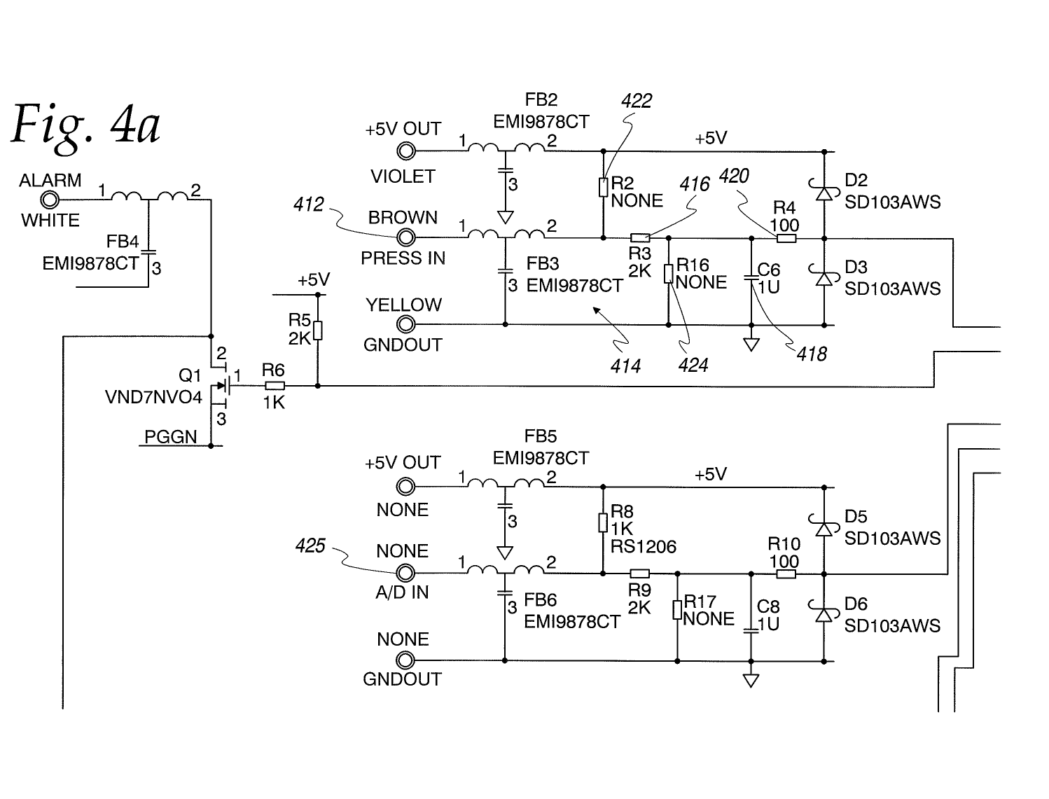

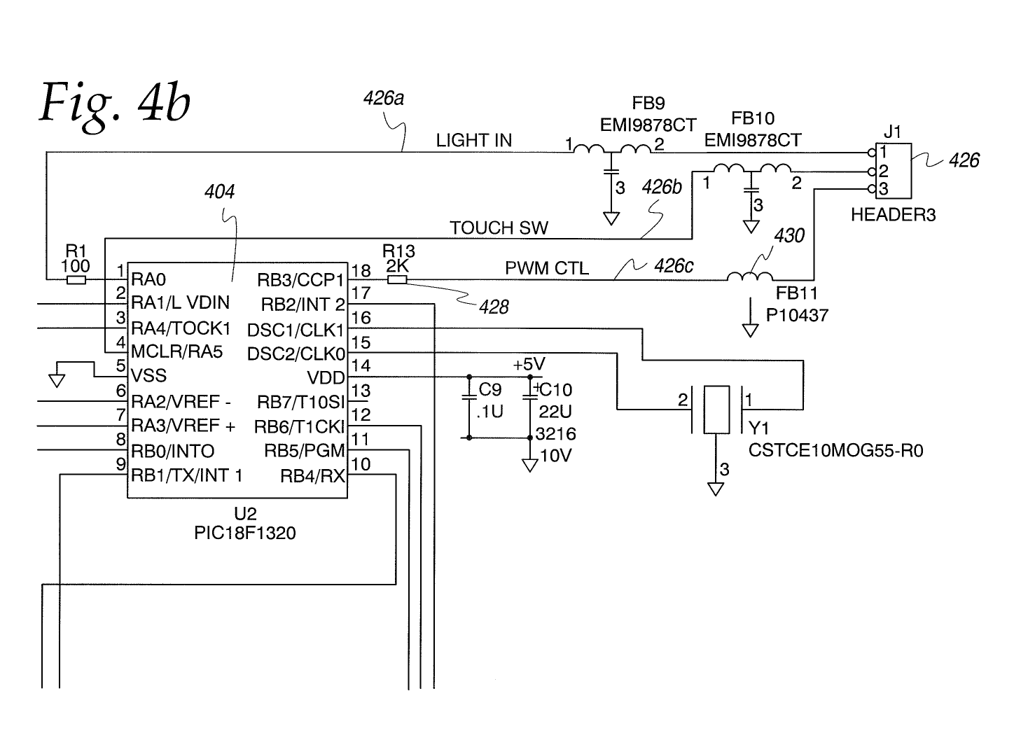

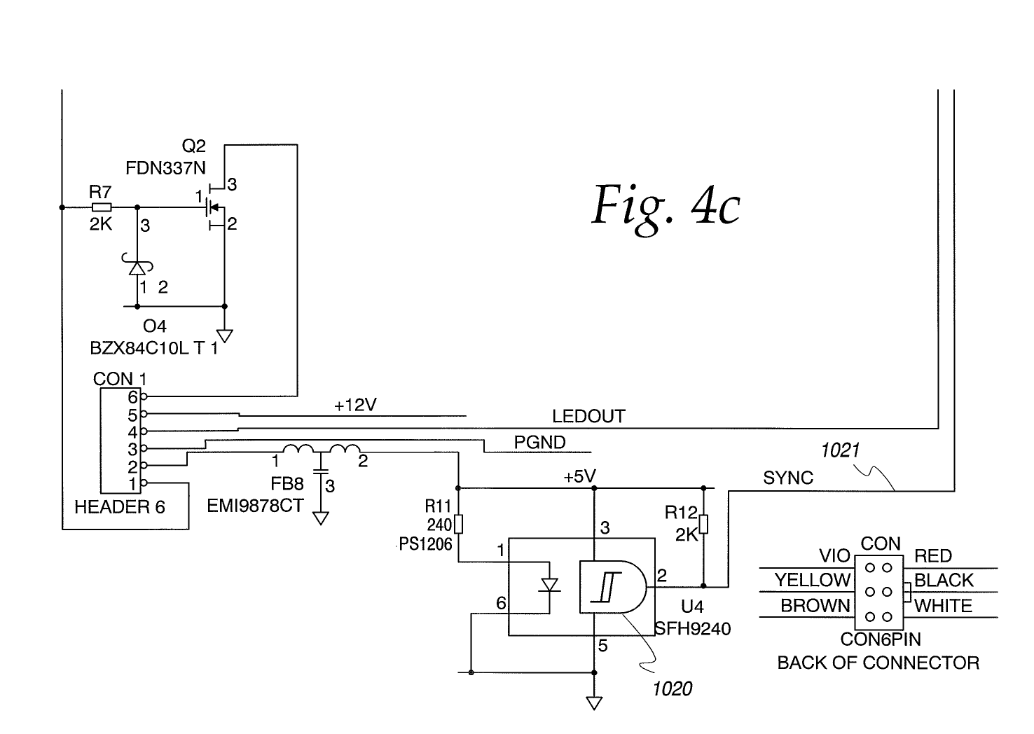

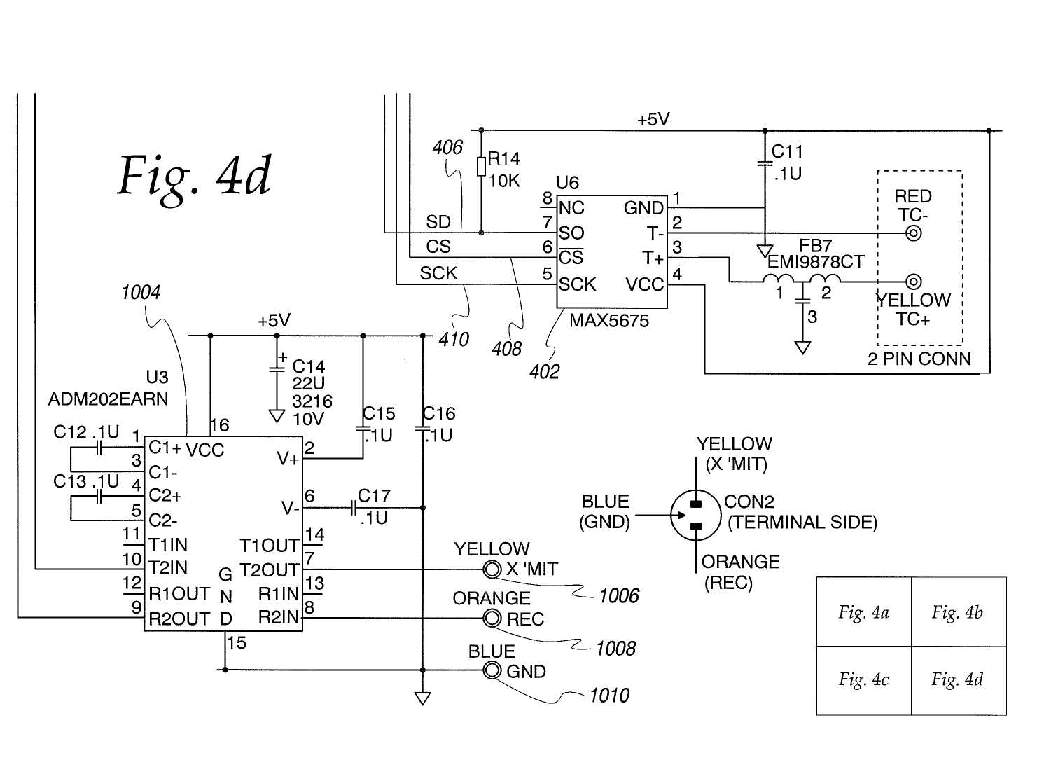

Referring now to FIGS. 4-10, various examples of gauge circuits that are used to display one or more arcs of light are described. These circuits are used to implement some or all of the elements of the functional block diagram of FIG. 1. In these examples, the gauges receive various combinations of RPM information, temperature data, data from analog instruments (e.g., pressure information), and data from a communication bus (via a Universal Asynchronous Receiver Transmitter (UART)). It will be understood that the circuits of FIGS. 4-10 are examples only and other types/combinations of circuitry, components, and/or component values may also be used within these circuits. Furthermore, since in these examples many of the components, component values, and connections are identical, like numbers have been used between drawings and it will be understood that these like-numbered components perform the same or similar functions in each example in which they are referenced.

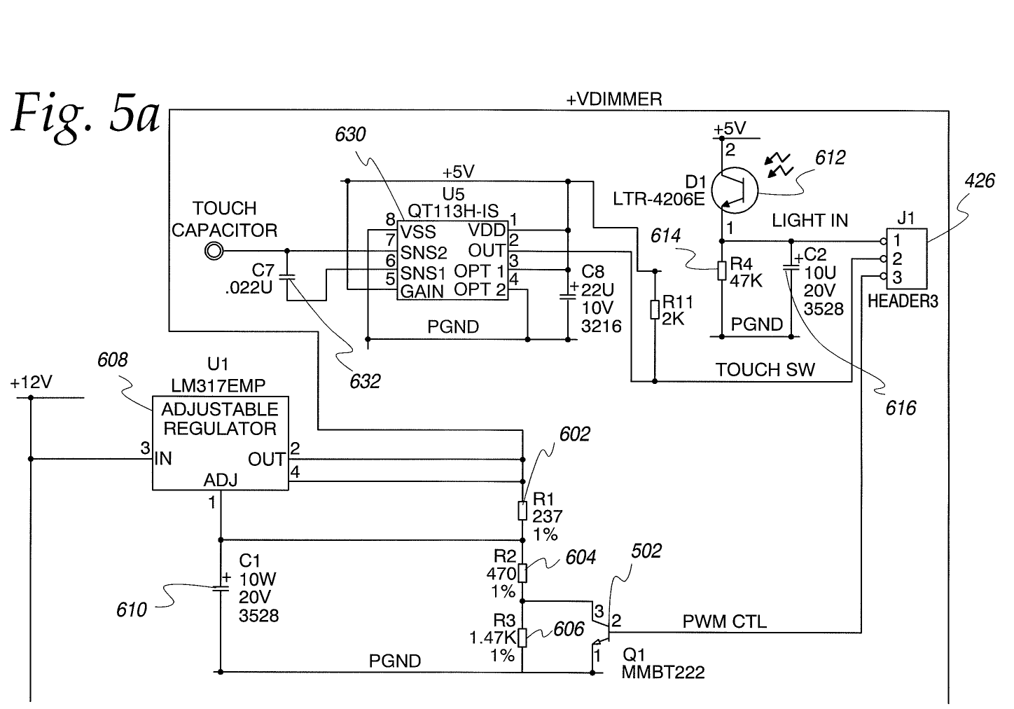

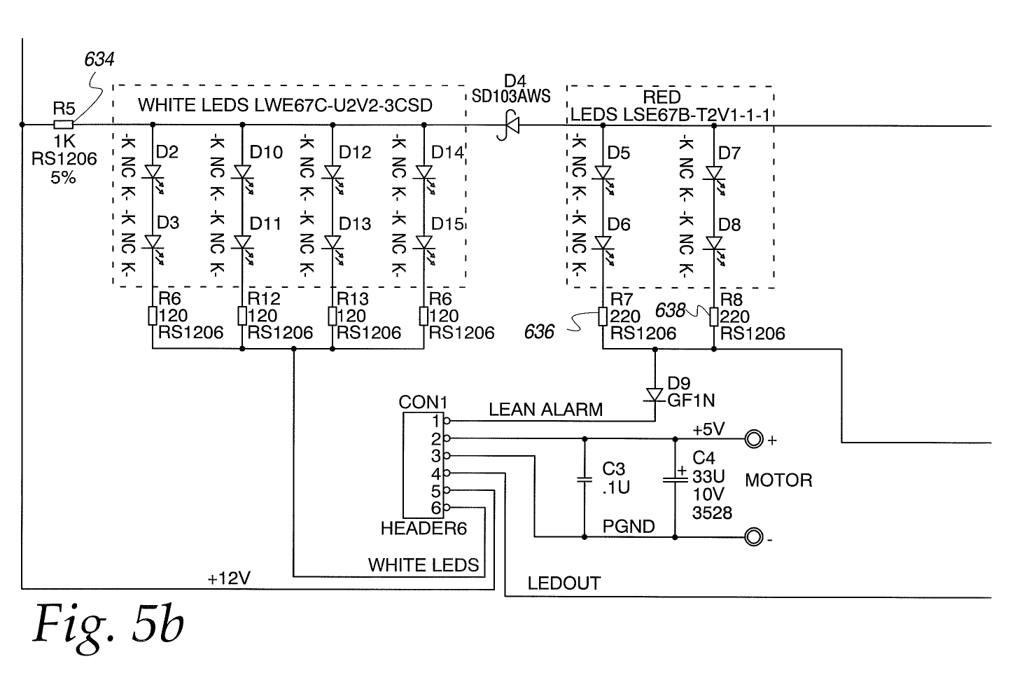

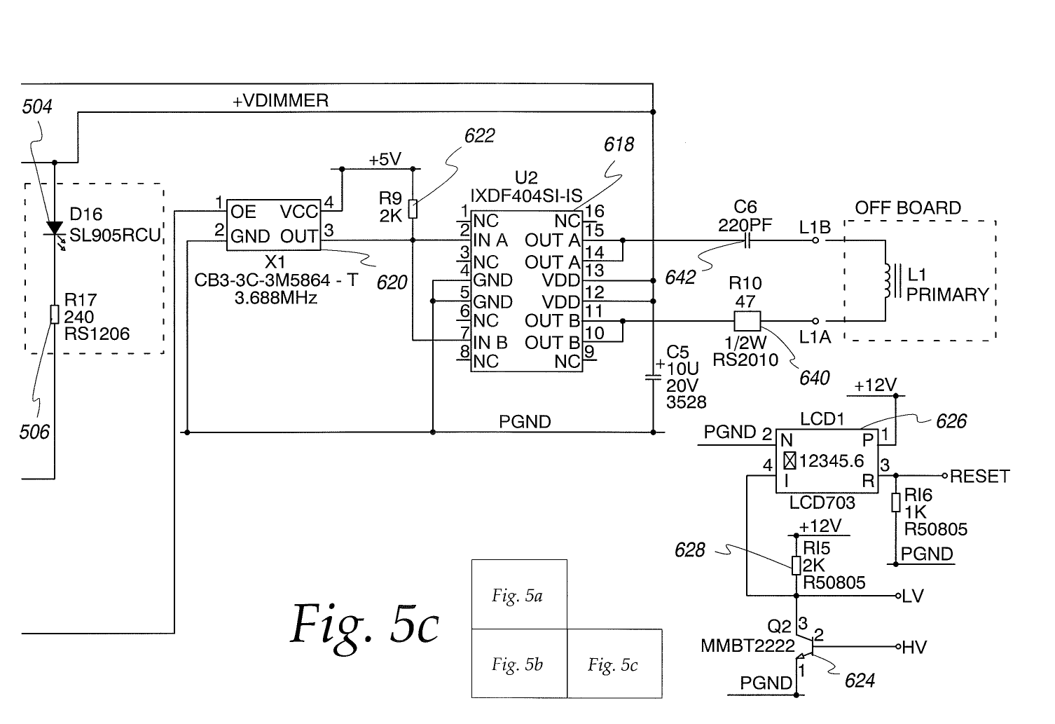

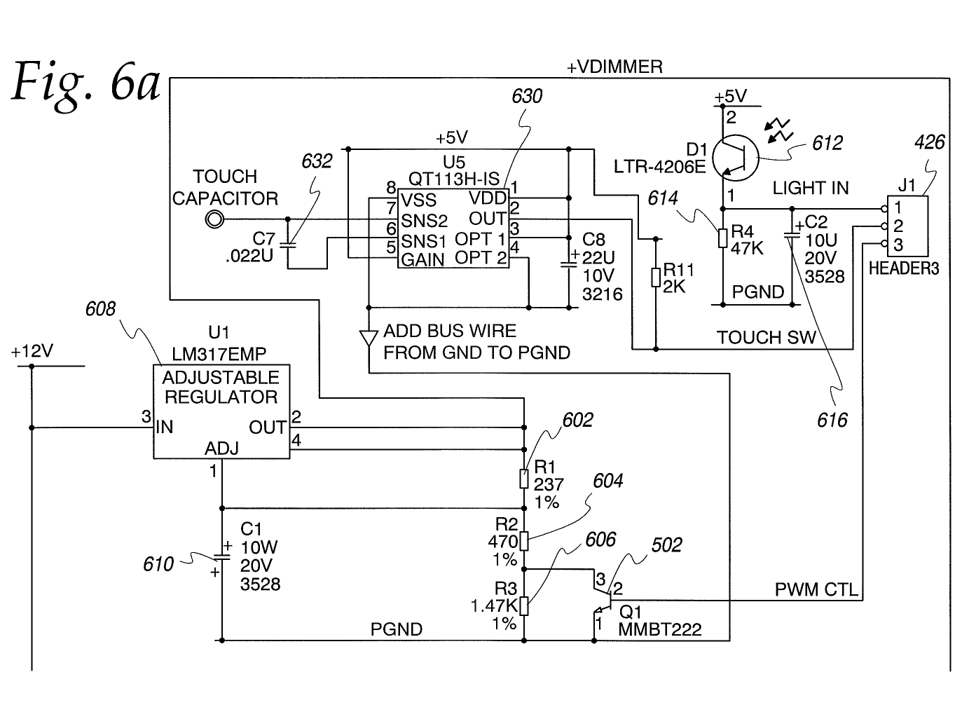

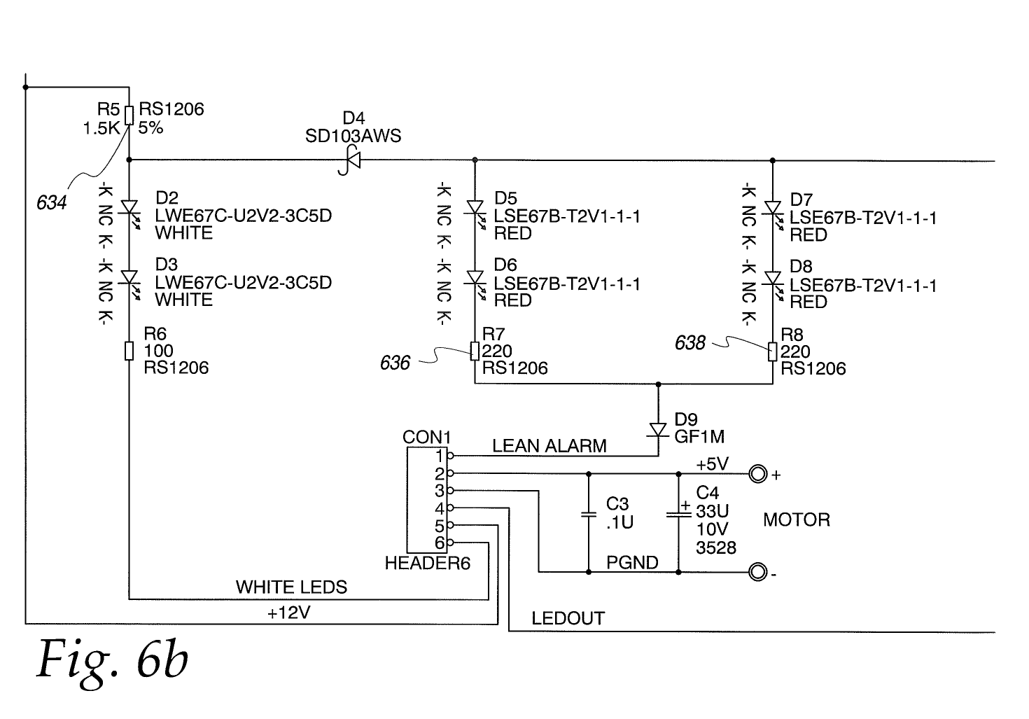

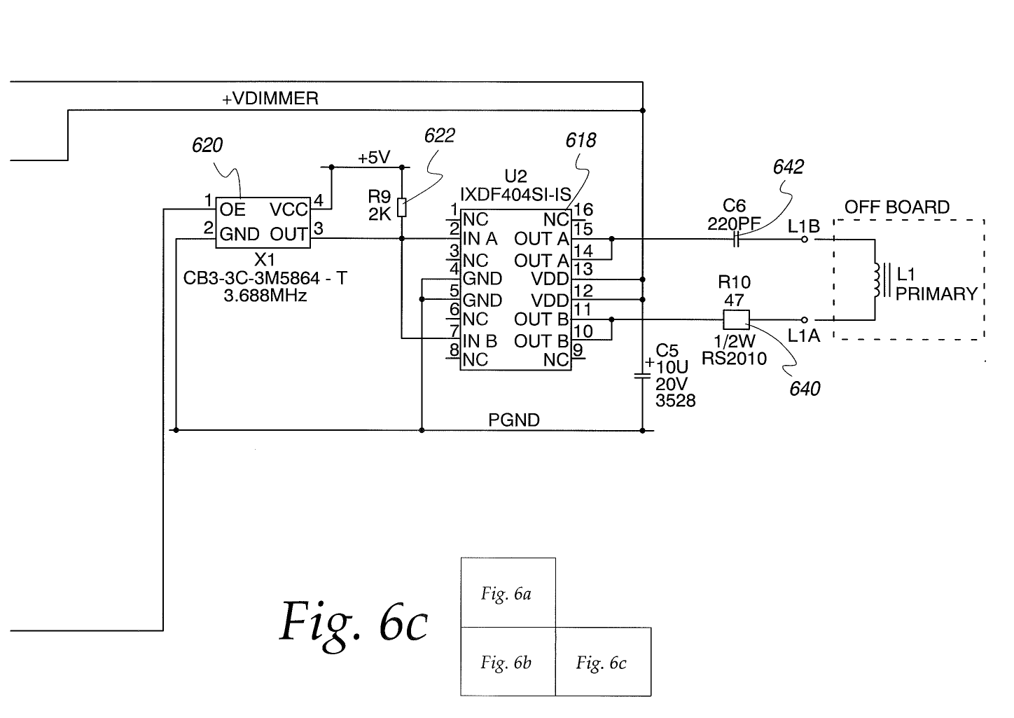

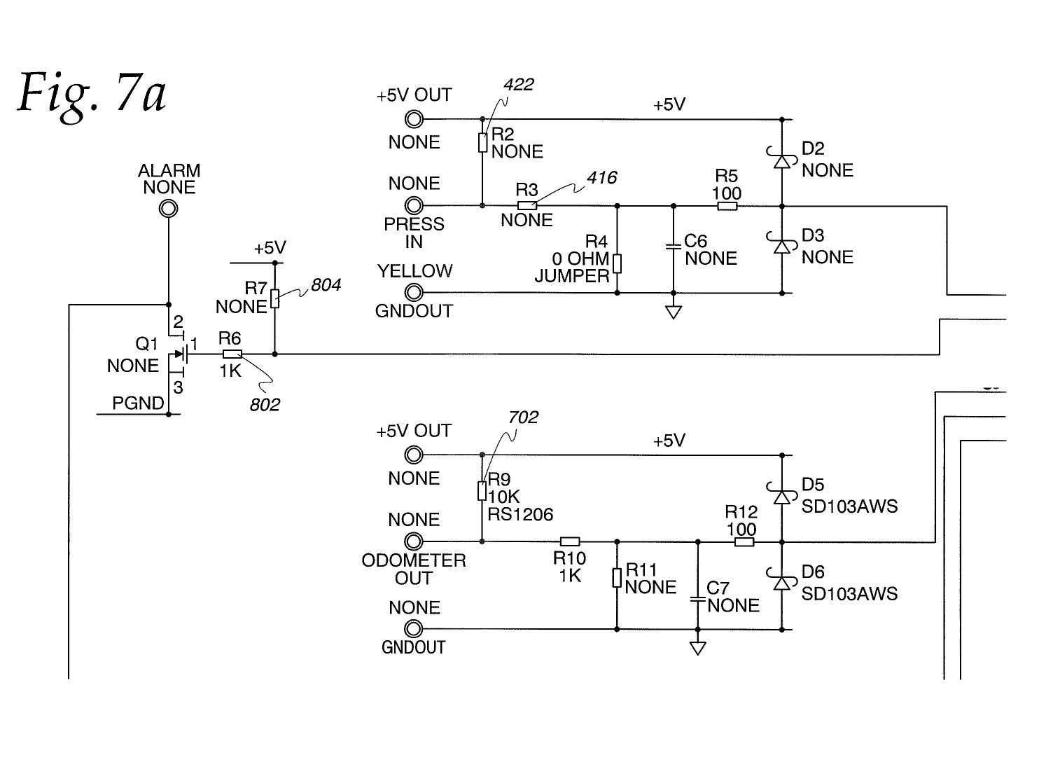

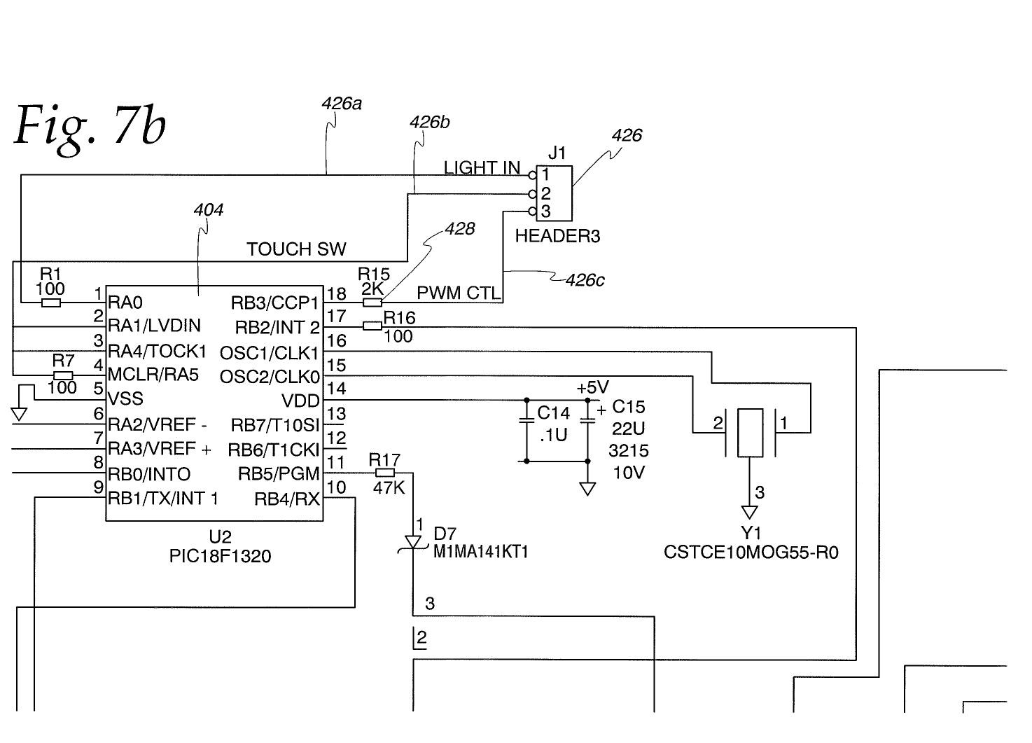

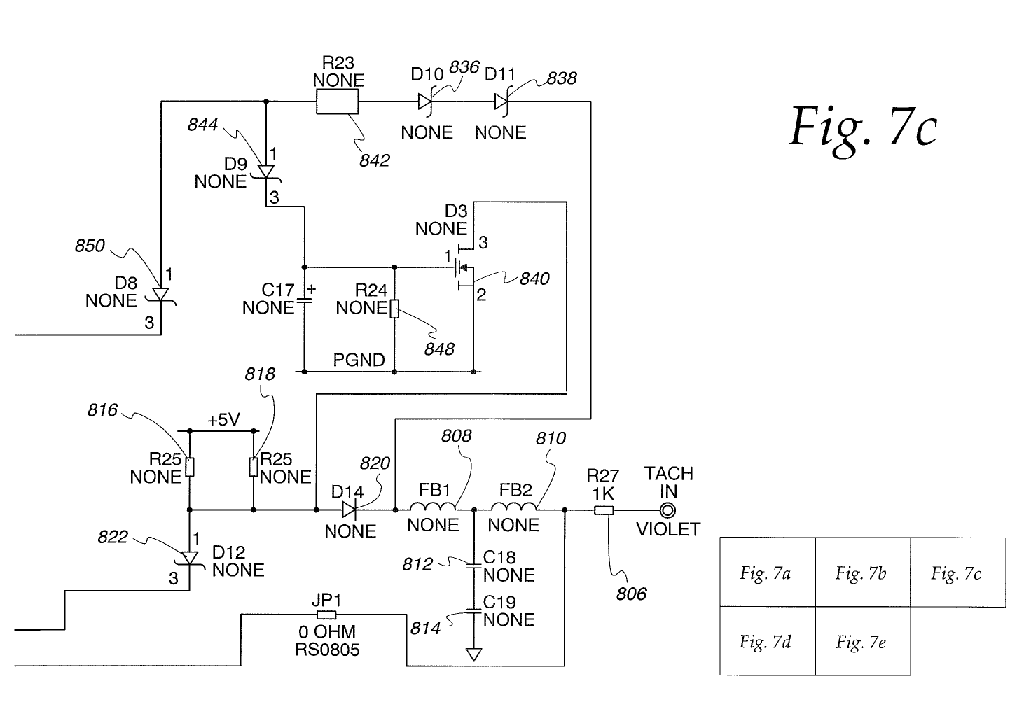

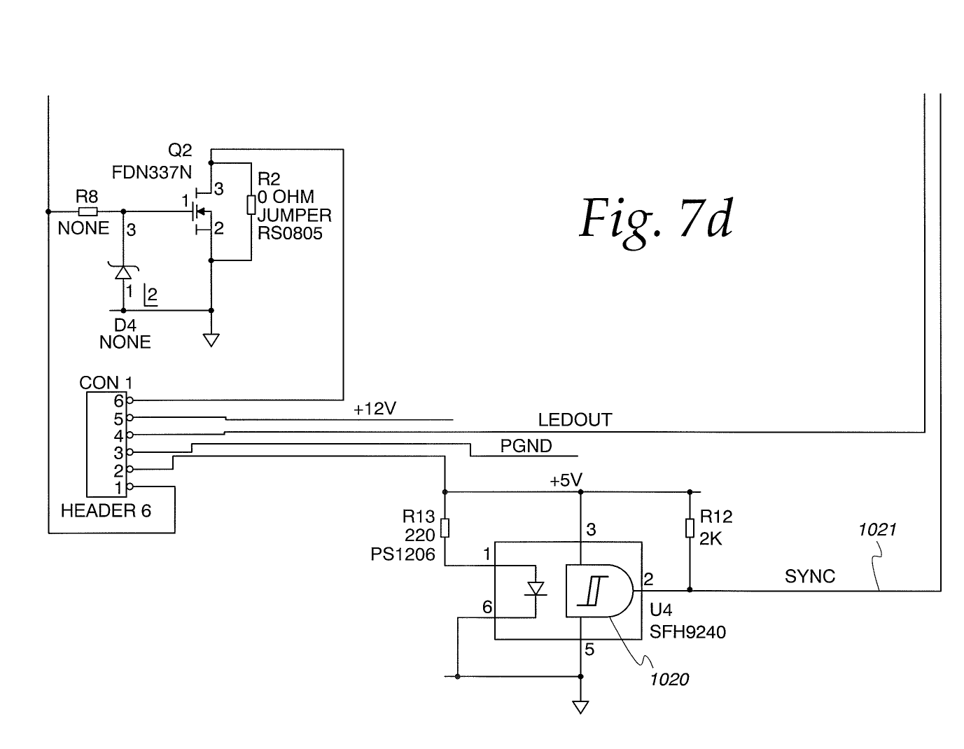

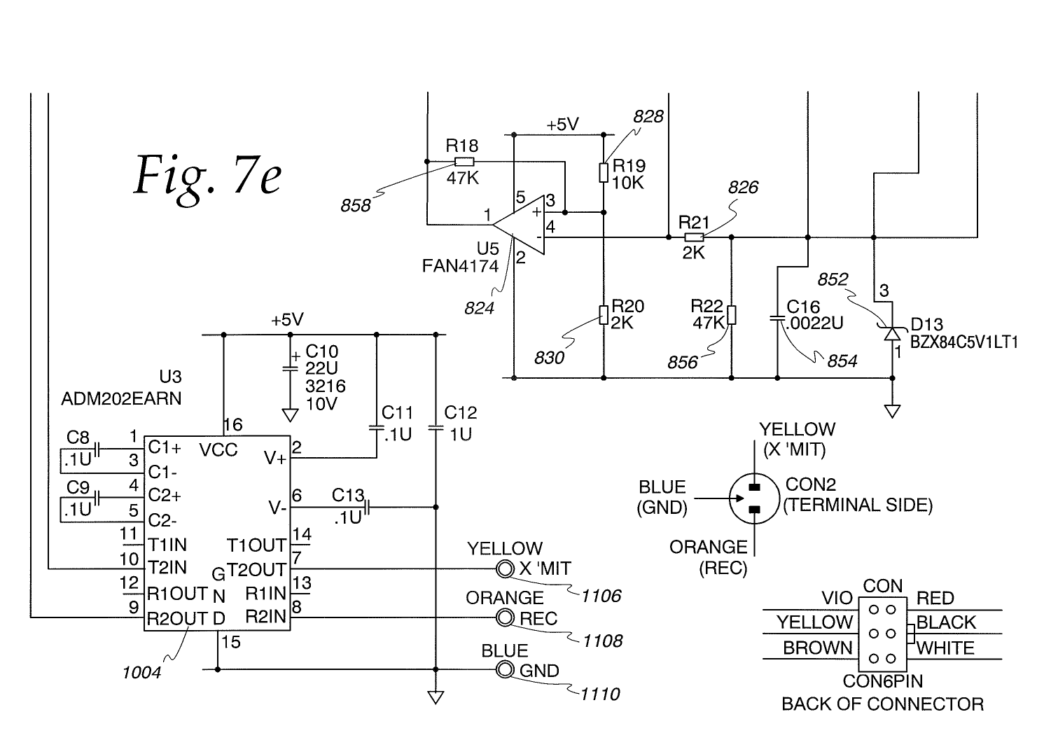

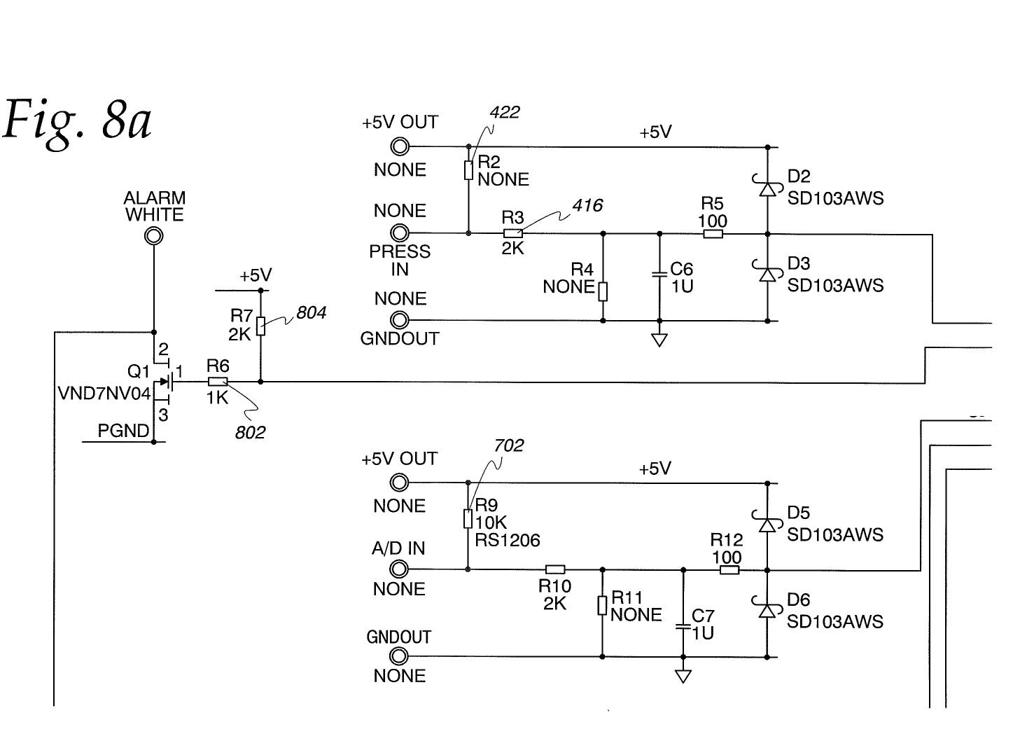

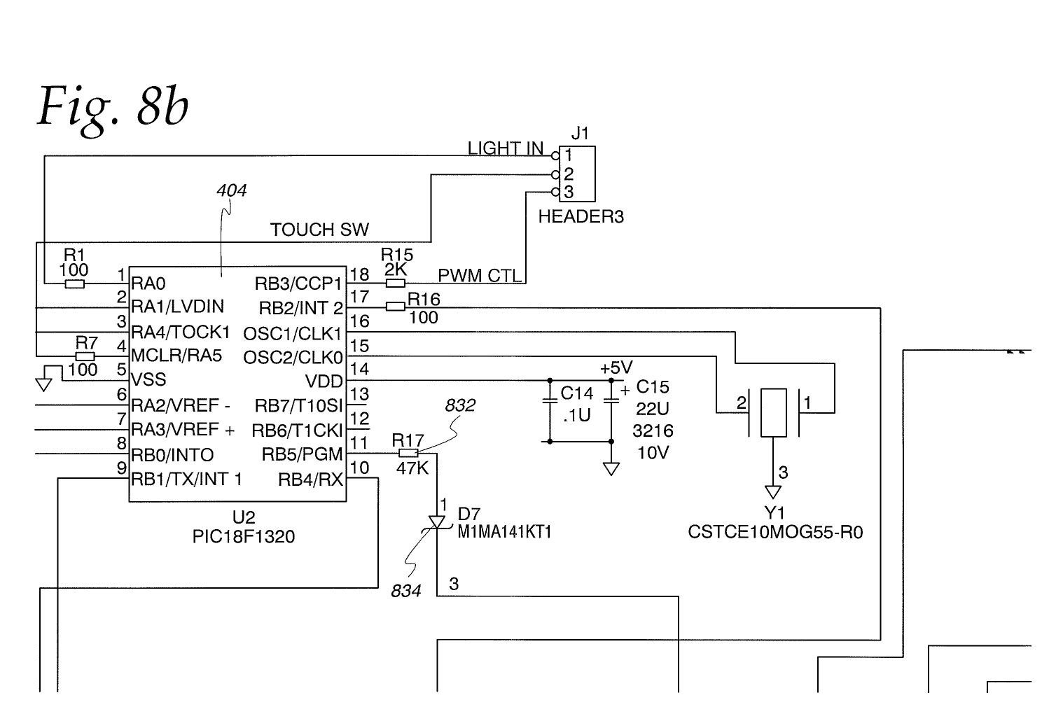

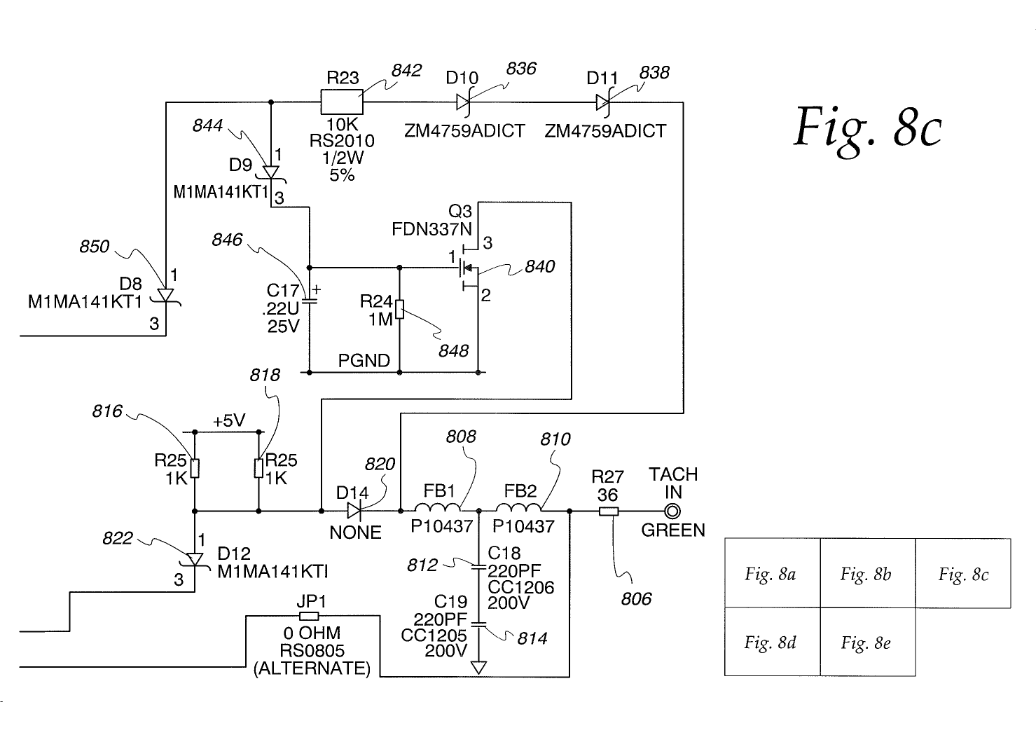

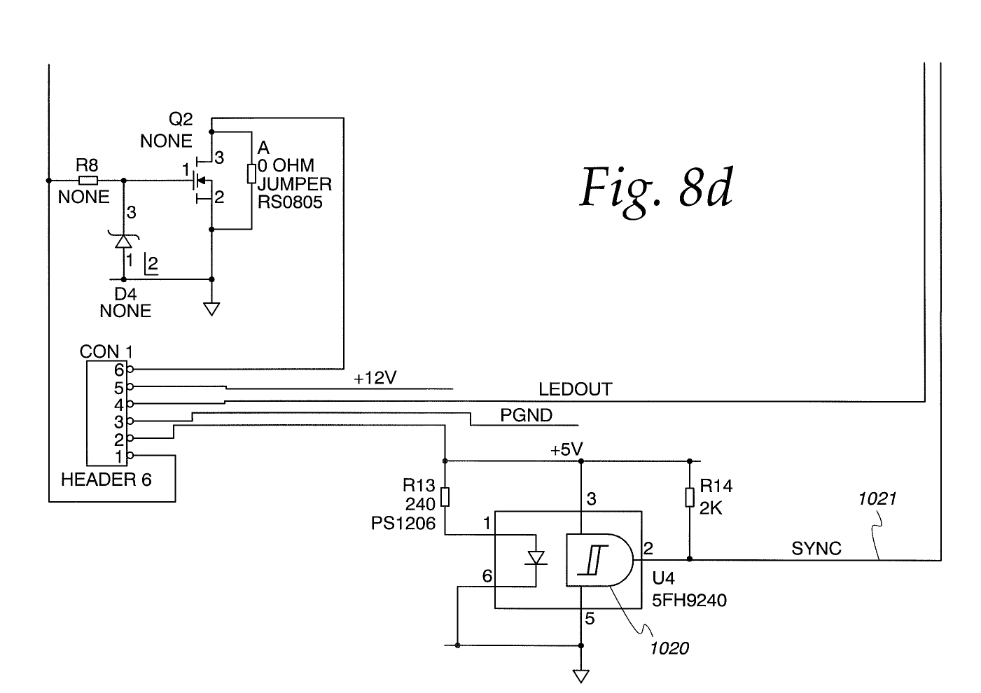

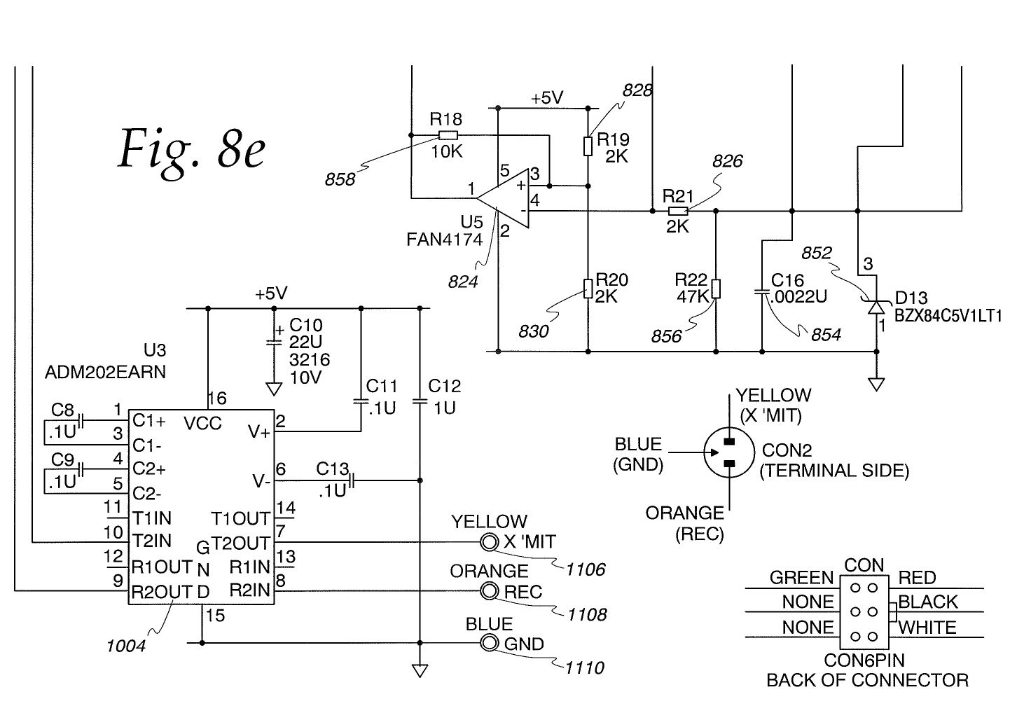

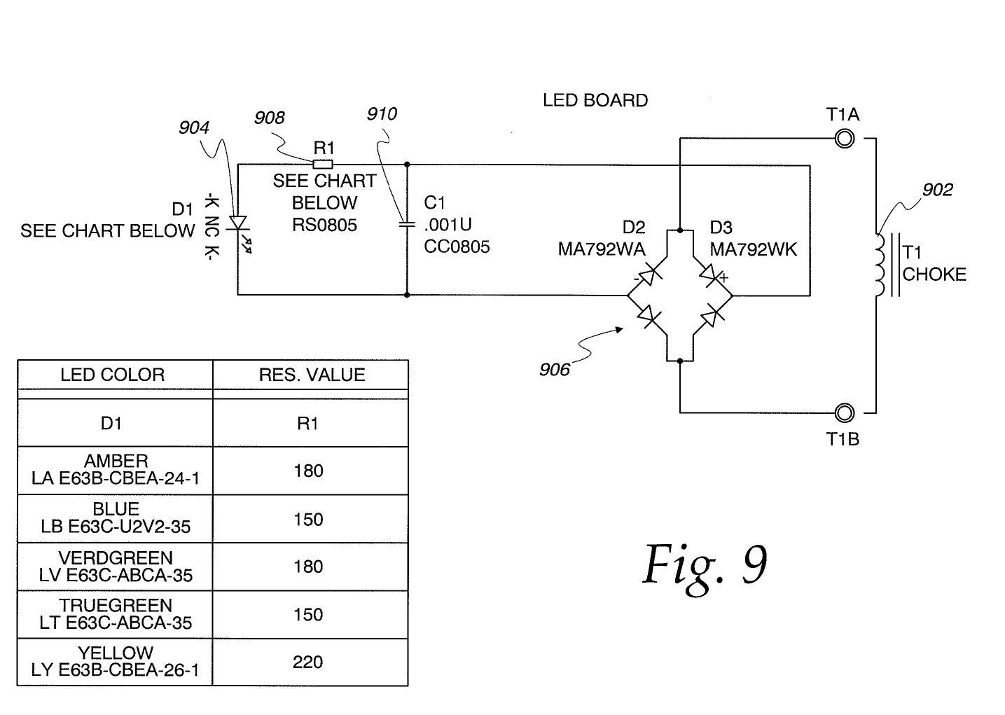

The circuits shown in FIGS. 4-10 represent and encompass individual circuit boards. For instance, the circuits of FIGS. 4, 7, 8 and 10 are control boards housing a microcontroller. FIGS. 5 and 6 are motor boards and are used for driving the motor (and hence the light pointer). FIG. 9 is one example of a board implementing the functions of the light pointer. Similar types of boards differ based upon the type of gauge in which they are used. For instance, the board in FIG. 8 may be used in tachometer-type gauge while the board of FIG. 7 may be used in an odometer-type gauge. It will be additionally appreciated that the circuits described can be placed on a single board or split across different boards than those shown in FIGS. 4-10.

The boards are interconnected as discussed in the following description to implement the functions of a gauge. For instance, a control board may be connected to a motor board and a motor board may be connected to the light pointer board.

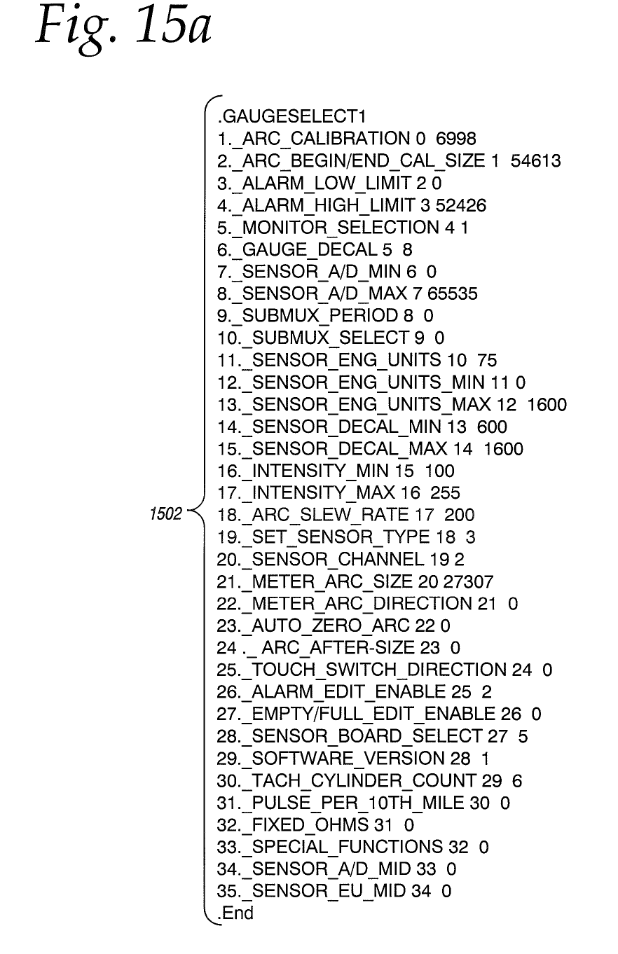

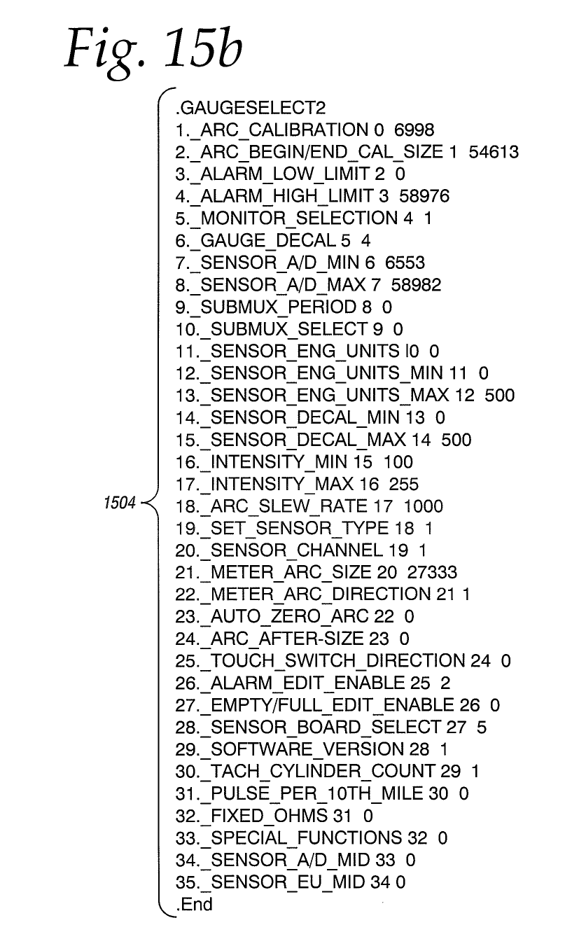

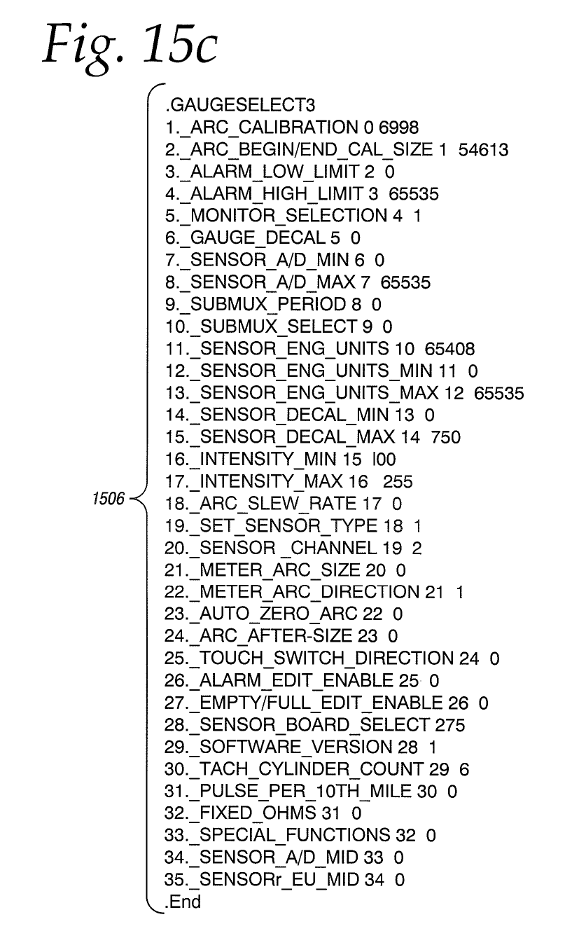

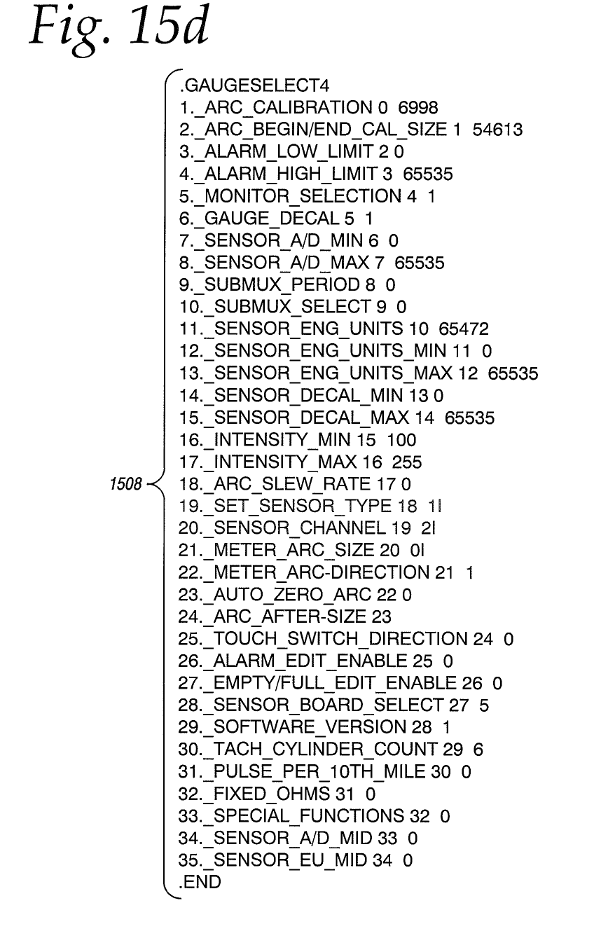

In addition, the boards are programmed to use different computer-implemented files (e.g., parameter configuration files such as those shown in FIG. 15) in order to operate. Some of the parameters used in the files are included in the following description. It will be appreciated that other parameters and other values for these parameters may also be used.

Referring now specifically to FIG. 4, a control board for a gauge includes an SPI thermocouple amplifier connected to an external type-K thermocouple, which is positioned in the engine exhaust, and this amplifier is used to measure the temperature of the exhaust gas. This temperature is measured by an IC 402 (U6) and the IC 402 may be a MAX6675 manufactured by Maxim, Inc. The IC 402 communicates the temperature information to a microcontroller 404 (U2) over the SPI corn port of the IC 402. As is shown in FIG. 4, three pins are connected between the microcontroller 404 and the IC 402, which are labeled SD 406, CS 408, and SCK 410. These pins function as serial data, chip select, and serial clock inputs. The microcontroller 404 queries the IC 402 (U6) to begin the temperature data transfer from the IC 402 (U6) to the microcontroller 404 (U2) and that transfer takes a predetermined number (e.g., 16) of clock cycles of the SCK output.

In one example, the data from the IC 402 (U6) has 12-bit data resolution with a range of 0 to 1024 degree Celsius temperature measurement. In one example, this data transfer occurs at rate of about two times per second. After the temperature data is received by the microcontroller 404, the temperature is then converted to a format to be displayed by the light pointer. Specifically, the microcontroller 404 includes software routines for capturing the data, scaling the data from degrees Celsius to degrees Fahrenheit, and converting the data into a form that is displayable as an arc of light.

The microcontroller 404 also has two analog inputs 412 and 425 (PRESS IN) as well as the SPI temperature input. The analog input 412 (PRESS IN) is connected to an external pressure sensor (not shown), such as a 75PSIG type sensor available from Honeywell, Inc. or Texas Instruments, Inc. The pressure sensor is connected to +5 volts at the terminal +5 VOUT, ground at GNDOUT and the input signal to PRESS IN. The sensor used may be of the ratio metric type output, which, in one example, has a range of about 0.5 vdc to 4.5 vdc with an excitation of +5 vdc. The lowest pressure is at 0.5 vdc and highest pressure at 4.5 vdc.

The PRESS IN terminal voltage is filtered from RF noise by an input ferrite/capacitive filter 414 (FB1) and then passed through a current limiting resistor 416 (R3), which is, in this example, a 2K ohm resistor. The resistor 416 is coupled to a capacitor 418 (C6), in this example, a 1-microfarad capacitor, forming a low pass filter with a time constant of 2-milliseconds. The filtered signal is passed on through current limiting resistor 420 (R4), a 100 ohm resistor, and clamped by diodes D2 and D3 (both Schottky diodes) to clamp the signal at input pin 2 of the microprocessor 404 (the analog input) within the maximum input rating of the microcontroller. As with the temperature data, after the pressure data is received by the microcontroller 404, the pressure information is then converted to an appropriate format to be displayed by the light pointer.

Additional resistors can be inserted at the analog input to pull up the signal or external sensor pin (e.g., resistor 422 (R2)), and/or to +5 vdc and/or to divide the input signal with the addition of resistor 424 (R16), which forms an input voltage divider with resistor 416 (R3). When the input signal is greater than the normal maximum of +5 vdc, the divider is used to attenuate the input signal to limit the range to within the 0-5 vdc range of the microcontroller analog input. If the signal contains voltage spikes above or below the normal operating input voltage range, diodes D2 and D3 clamp the voltage at the microcontroller 404 to within approximately +/−0.4 volts of the microcontroller power supply rails providing protection from damaging the microcontroller 404.

The second analog input 425 (A/D IN) is provided with similar filtering, pull up resistor and attenuation resistor, and protection clamping diodes at the analog input 412 (PRESS IN). Other data may be input to this terminal for data to be displayed by the light pointer.

The LED white backlight, red alarm light and light pointer intensity are all controlled by the microcontroller 404. As shown, the microcontroller 404 has three control lines at input 426 (HEADER3) that connect to the motor/display board described with respect to FIGS. 5 and 6.

The control lines include lines 426a (LIGHT IN), 426b (TOUCH SWITCH), and 426c (PWM CTL). The control line 426c (PWM CTL) is the pulse width modulated (PWM) output pin from the microcontroller 404 (U2) to the voltage regulator control connected to base of a transistor 502 (Q1) (e.g., an NPN transistor) through a resistor 428 (R13) and filter 430 (FB11) found in FIGS. 5 and 6.

Referring now to FIG. 6, the collector of the transistor 502 is connected to divider string of resistors 602, 604, 606 (R1, R2, and R3). The adjust terminal of linear voltage regulator 608 (U1), (e.g., an LM317 voltage regulator) is connected to resistor node of resistor 602 (R1) and resistor 604 (R2) and filtered by a capacitor 610 (C1), which, in this example, is a 10 microfarad capacitor. The voltage regulator is controlled by the microcontroller 404 (U2) and can be programmed by the touch switch to allow the user to program, for example, the maximum and minimum light pointer, alarm, and backlight brightness relative to the ambient light level input.

The resistor 602 (R1) is connected between the output pin and adjust pin of the voltage regulator 608 for feedback. Resistor 604 (R2) connects to the adjust pin of regulator 608 (U1) and the collector of the transistor 502 (Q1). With the transistor 502 (Q1) biased off, the transistor 502 (Q1) has a base voltage of zero volts, and the output of the regulator 608 (U1) is at the highest output voltage of about 10.2 volts DC. In this example, when transistor 502 (Q1) is driven on by the microcontroller PWM output, the collector of the transistor 502 (Q1) shunts resistor 606 (R3) (e.g., a 1.47K ohm resistor) and causes the voltage reference at the adjust pin of the regulator 608 (U1) to decrease as the capacitor charges/discharges via the resistor 604 (R2) to ground.

At small PWM duty cycles, the capacitor 610 (C1) is discharged to only a small percentage of capacity and only drops the reference voltage of the regulator 608 slightly, resulting in a small drop in the voltage regulator output. As the duty cycle increases, the capacitor 610 (C1) discharges to a much lower value resulting in the reference voltage decreasing and the output voltage decreasing. At 100% duty cycle the transistor 502 (Q1) remains on thereby discharging the capacitor 610 (C1) to the lowest value set by the divider pair resistors 602 and 604. At 100% duty cycle the voltage regulator output is at the lowest value of about 4 volts DC. The filtering action of C1 and R2/R1 provides a smooth DC reference voltage at the adjust pin of U1 since the PWM frequency is over 1 kHz and the discharge time constant is 4.7 ms.

This control of the voltage regulator 608 by the microcontroller PWM output then sets the intensity of the LED on the light pointer by adjusting the LED drive voltage resulting in the change in LED forward current bias. This allows the microcontroller 404 to adjust the intensity of the back light, alarm light and light pointer.

The user may program various parameters, which are stored in the EEPROM of the controller 404. In this regard, FIG. 15 shows examples of parameter files that can be used. The files consist of a number of parameters 1502, 1504, 1506, and 1508 each having certain values. The parameters 1502, 1504, 1506, and 1508 control or are used to control various aspects of gauge operation. The example of FIG. 15 shows four configuration files each relating to a different gauge or gauge type.

More specifically, the parameters in the configuration files control the display of the arcs of light on the gauge. For instance, in some types of applications, it is desirable to display two sets of information to appear as a single arc of light (i.e., the arcs are slew locked about a common base point). In this case, the common base point on the display is chosen and one arc grows in length from the base point in the clockwise direction and the other arc grows in length from the base point in the counterclockwise direction. In one specific example, a gauge that has one sensor input (such as manifold absolute pressure or MAP input) receives both a vacuum value and a boost pressure value that are to be displayed. In this case, the gauge indicia may have a range of 0 to 30 inches hg for the vacuum information, and 0 to 30 psi for the boost pressure information. In one example, the data is presented on the display to appear to the user to be one arc that originates from the zero indicia (base point) growing in length in the counter clockwise direction for vacuum input and growing in length from the zero indicia in the clockwise direction for pressure input. In this example, the observer only sees one arc of light that seamlessly moves from the zero indicia either clockwise or counter clockwise.

One advantage of slew locking two arcs of light is to keep the movement of the arc of light moving from one end of travel of the first gauge seamlessly through the beginning of the next gauges beginning value. Since the arc is moving at a slewed value, if the two gauges were not slew locked the arc could appear as two separate arcs when the signal is changing quickly from one meter to the next meter. This action does not occur when the two arcs of light are slew locked. As in the vacuum/boost gauge, both the vacuum gauge and the boost pressure gauges are slew locked with arcs moving opposite directions from the zero indicia. With the slew lock function selected, the arc of the vacuum gauge must move to zero before the boost gauge is allowed to grow the arc from zero for pressure indication.

In this example, parameter #33 from the configuration file in FIG. 15 can be programmed to tie (slew lock) the display of two informational streams together. Specifically, with the configuration parameter #33 set to value of 1 or 3, the two gauges are slew locked so that the two gauge arcs appear as a single arc of light.

Also in this example, parameter #18 from the configuration file of FIG. 15 can be used to set the slew rate of the gauge arcs that are displayed. When this value is set to a small value, for example, 100, the speed of the arc is limited to about 8 seconds to grow from zero to full scale. The smaller the parameter #18 value is, the longer the arc takes to grow in length. A parameter #18 value of 10,000 would allow the arc to grow from zero to full scale in 0.08 seconds. The range of the slew rate is programmable from 0.08 seconds at 10,000 to 14 minutes at 1. A slow rate may be used for a gauge that may have noise or perturbations of the input sensor signal. For example, a fuel tank sender unit (sending fuel level information) may have signal perturbations caused by the fuel sloshing from the front to the back of the fuel tank when the vehicle is accelerated or decelerated, or from sloshing the fuel from side to side when, for instance, the vehicle turns a corner. For the fuel gauge application a slow slew rate is programmed such as a value of 10 or less giving at least 82 seconds for the arc to move from Empty to Full on the indicia. For fast gauges such as a tachometer, the arc is desired to move quickly to keep up with the acceleration of the engine. It is possible for a race engine to accelerate from idle speed to 8000 RPM in less than ±2 second requiring that the slew rate be set for a value of about 1500 to 2000.

In another example of application of the present approaches using display parameters, the signal from the MAP sensor connected to the Vacuum/Boost gauge is captured at power up, which captures the atmospheric pressure for indicating zero on the gauge face indicia. This operation is configured by parameter #23 of the configuration file of FIG. 15. When parameter #23 is programmed to a value of 1, the sensor input is automatically captured as the zero value on the gauge indicia. Once the engine is started, any vacuum measured is indicated by an arc of light. When the turbocharger of the engine begins to raise the manifold pressure, the light arc moves toward zero then enters the boost indicia from the zero indicia indicating boost pressure relative to atmospheric pressure. In one example, the mechanical vacuum/boost gauge has an offset error caused by the value of atmospheric pressure that is relative to weather and altitude. In this case, the mechanical vacuum/boost gauge may have a very wide zero range on the indicia because of this error. Advantageously, the present approaches provide accurate displays regardless of altitude, weather, or other types of adverse conditions.

It will be understood that not all of the configuration parameters are required to be programmed for each specific gauge type. For example, for vacuum/boost gauges, the parameters #30, #31, and #32 are not required to be programmed and are not used by the gauge as they are specific for tachometers (parameter #30), speedometers (parameter #31), or fuel gauges (parameter #32).

In still another example of parameter usage, the PWM output of the microcontroller 404 is controlled by the configuration parameters #16 (for minimum arc intensity) and parameter #17 (for maximum arc intensity) and these values are set by the user. The input 426a (LIGHT IN) to the A/D input of the microcontroller 404 is connected to a photo sensitive device 612 (D1) in FIG. 6. In this example, the photo sensitive device 612 (D1 (e.g., an LTR-4206E photo diode) that is more conductive as the ambient light reaching the surface increases. At near full illumination of device 612 during mid-day sunlight, the device 612 is at its lowest resistance and provides a voltage of about 4.3 volts across a resistor 614 (R4), for instance, a 47K ohm resistor, connected to ground and a capacitor 616 (C2) and the output of the device 612.

The capacitor 616 (C2), in this example, a 10 microfarad capacitor, is positioned across the resistor 614 (R4), filters any instant ambient light changes so that the LIGHT IN signal slowly changes to provide an averaged signal to the microcontroller A/D input. At this voltage level the microcontroller functions to set the PWM output at 0% duty cycle or zero volts output if parameter #17 (programmed by the user) is at a maximum value of 255, keeping Q1 biased off, which results in the maximum output voltage of the regulator 608 (U1), about 10.2 volts DC providing the highest intensity of the LEDs on the light pointer. As the light input to the device 612 (D1) decreases, the voltage across the resistor 614 (R4) decreases and the microcontroller 404 begins to adjust the duty cycle relative to the input voltage and is limited only by the parameters #16 and #17. At times of no illumination of the device 612 (D1), such as at night, the voltage across the resistor 614 (R4) drops to less than 0.5 volts DC.

The microcontroller 404 controls the PWM to the 100% duty cycle value if the parameter #16 is set to the minimum value of 0. When the parameters #16 and #17 are set to other values between 0 and 255, the PWM output will be clamped to PWM values greater than zero and less than 100% duty cycle to limit the minimum and maximum LED intensity levels. Thus, the parameters #16 and #17 allow the user to select the minimum intensity at night and maximum intensity for daytime use of the arcs of light.

In one example, the parameter #16 from the configuration file of FIG. 15 is set to a value of about 100 and the parameter #17 to a value of approximately 255 when using a blue light pointer. The programming of parameter #16 and #17 can be changed by having the user program these values using the GUI. The light pointer is driven by the rotary transformer and rectified by diodes 906 (D2 and D3) in FIG. 9. The full wave diode bridge is then filtered by the capacitor 910 (C1), a 0.001 microfarad capacitor and then current limited to about 30 milliamps by series resistor 908 (R1), in this example, a 150 ohm value driving the device 904 (e.g., a blue LED).

The secondary transformer bobbin 902 can be seen attached to the light pointer board for the complete pointer assembly. The primary of the rotary transformer is connected to the driver IC 618 (U2) in FIG. 6. In one approach, the driver IC 618 is a dual MOSFET driver with one non-inverting and inverting driver such as the IXDF404SI-16 from IXYS Semiconductor. The driver circuit 618 inputs are both connected to the 3.68 MHz clock driver 620 (X1), which is gated on and off by the microcontroller 404 (U2) in FIG. 4.

A Zytel bobbin with strain relief pins on the pointer bobbin which align to the pointer PCB can be used. The primary bobbin may also be molded from Zytel plastic for a precision fit part to the motor while providing a very close tolerance to the pointer bobbin.

The signal labeled LEDOUT is the signal coming from the microcontroller 404 to the clock driver 620 (X1) enable pin to turn the clock on and off. In this example, when the LEDOUT signal is high, the clock output changes from a tri-state output to an active output providing a 0-5 volt, 3.68 MHz clock signal to the clock driver 618 inputs. A resistor 622 (R9), in this example, a 2K ohm resistor, provides +5 vdc bias to the driver input when the clock output is in tri-state. The type of clock IC used provides for adequate speed of turn on and turn off of the clock driving the light pointer and, preferably, is capable of turning on and off in 100-nanoseconds, thus providing quick turn-on and turn-off of the LEDs on the light pointer. This fast on/off switching of the clock gives the light pointer a precise position on the gauge face indicia. If a slower clock were used, the light pointer would appear smeared and lose the precise positioning to the indicia. In one example, the clock IC can be a CB3-3C-3M6864-T from CTS, Inc.

FIG. 4 also shows that the microcontroller 404 (U2) is connected to a chip 1004 (RS232 IC-U3). The microcontroller serial communication port transmit (Tx) and receive (Rx) terminals are connected to chip 1004 (U3) and the output port of chip 1004 is connected to a 3-pin connector or to an external connector to allow connection to a personal computer that is running the gauge GUI for configuration of the gauge. The PC serial connection is made at the terminals 1006, 1008, and 1010 (X′MIT, REC and GND).

One difference between the boards of FIGS. 5 and 6 is the physical size and dimensions of each of these boards. The board of FIG. 5 may be 3.25 inches diameter and require additional backlight LEDs, D2-D3 and D10-D15, white LEDs. Also, the circuit of FIG. 5 includes additional circuitry, including a LCD counter 626 (LCDI), a 6 digit counter to represent elapsed miles traveled for the odometer function in the speedometer type gauge. The odometer clock input, LV or HV is supplied by the microcontroller 404 output when parameter 19 is programmed to value of 5. In contrast, the board of FIG. 6 may be smaller.

The output at pin 6 of the microcontroller 404 (U2) in FIG. 7 provides an output clock signal for every 1/10 mile traveled at terminal ODOMETER OUT. This signal is normally high at +5 vdc and pulses low for about 10 ms every 1/10 mile traveled.

The resistor 702 (R9) is a pull up to +5 volts to insure at power on that there is no output clock signal to the LCD counter. The microcontroller clock output at terminal ODOMETER OUT in FIG. 4 is connected to the LCD clock driver transistor base terminal, 624 (Q2) in FIG. 5. In one example, the clock amplitude for the LCD counter 626 is 0 to +12 vdc, so a resistor 628 (R15) is provided. In this example, a 2K ohm resistor, is connected between +12 volts supply and the clock pin of LCD1 counter 626. When the microcontroller signal goes low transistor 624 (Q2) turns off and the clock pin goes high, to +12 volts, incrementing the count on the LCD counter 626. The LCD counter 626 may be type such as a 703PR-112 from Curtis, Inc. The LCD counter 626 includes a reset input as shown in FIG. 5, which can be activated by momentarily connecting to +12 volts to reset the count displayed on the LCD counter 626 during gauge testing.

Also, in FIGS. 5 and 6, an integrated circuit switch 630 (U5) for the touch switch is installed, which is a type such as a QT113H-IS or QT113-IS from Quantum Research Group. This is a charge transfer type capacitive switch that senses the proximity of the finger touching the lens of the gauge face. The switch 630 provides the gauge with several functions depending on the configuration parameter values and the alarm or function being edited. The input to the switch 630 (U5) is from a conductive electrode, in one example, a silver silk screened on the back side of the gauge lens graphic film. The electrode is not visible to the user because of the graphics are printed on the film hiding the electrode layer. An alternative to a silk screened layer is a metalized film attached to the back side of the graphics with adhesive.

The electrode is connected by a wire pin with a small spring that is compressed to the electrode to the input of the switch 630 (U5) labeled “TOUCH CAPACITOR.” The value of a parallel capacitor 632 (C7), in this example, a 0.022-microfarad capacitor, is selected for the sensitivity of the touch switch 630 relative to the size of the electrode and dielectric of the lens and graphics material which are polycarbonate. The sensitivity is so designed with the dielectric material, electrode size and value of the capacitor 632 (C7) to provide touch sensitivity to the user's finger print or thumb print pressing the gauge lens to actuate the output of the switch 630 (U5).

When a touch is sensed, the output of the switch 630 (U5) changes level. For the switch 630 (U5) using the QT113H-IS the output switches high to +5 volt output, or the QT113-IS device can be used which switches the output low when a touch is sensed. The configuration parameter #25 is set to 0 or 1 to select the type of switch used on the gauge.

In FIGS. 5 and 6, a resistor 634 (R5) is connected to the vehicle supplied +12 volt supply and to LEDs D2-D3 or D2-D3 and D10-D15 to provide minimum LED intensity at the minimum voltage output of the regulator 608 (U1). The diode D4 blocks the voltage at the cathode when the output of the voltage regulator 608 (U1) is at the lowest level. This ensures that at night the minimum backlight intensity is fixed even if the minimum intensity parameter 16 is set to 0. The series white LEDs may require about 7-8 volts minimum bias for minimum light output. Since the voltage regulator 608 (U1) could output as low as 4 volts dc, the output of the regulator 608 does not provide any drive current to the white LEDs under full dark conditions. The series red LEDs only require about 3 volts for minimum light output so they still provide a minimum light output at full dark operation.

The white and red LEDs may be connected to provide constant white back light even when the alarm is turned on or they may be connected to turn off the white LEDs when the red alarm LEDs turn on. Referring again to FIG. 4, two transistors Q1 and Q2 switch the white and red LEDs from a drive signal from the microcontroller 404 at pin-3 of the microprocessor 404 (U2). In this configuration, when the output signal of the microcontroller 404 (U2) at pin-3 is low, Q1 is biased off, which allows a voltage from the white LEDs to bias the gate of Q2. Since the transistor gate of the transistor Q2 is a high impedance, no current flows to bias the white LEDs on, but charges the gate to source capacitance of the transistor Q2 turning it on. With the transistor Q2 biased on, the red LED current flows through the red LEDs, D5-D8, the series current limiting resistors 636 (R7) and 638 (R8) and through the drain terminal of the transistor Q2 to ground, illuminating the gauge with red light.

When the output of the microcontroller 404 (U2) at pin-3 is high, gate of the transistor Q1 is biased on, which removes the gate bias on the gate of the transistor Q2, turning Q2 off, turning the red LEDs off and providing current to flow through the white LEDs, current limiting resistors and the drain terminal of the transistor Q1 to ground illuminating the gauge with white light. Consequently, the gauge can be illuminated with white or red light using a single control signal.

Referring now to FIG. 7, a speedometer gauge circuit is described. It may be desirable in the speedometer circuit FIG. 7 that only white backlight of the gauge is desired and no red LEDs are installed in the gauge. In this example, the white LEDs are the only back light source and stay on any time the gauge is powered on. In FIG. 7, the transistor Q2 has been replaced with zero ohm jumper across the drain and source terminals to provide constant white LED current to flow through the LEDs for white light illumination. A number of components are not used in this configuration such as the transistor Q1, resistors R6, R7, and R8, diode D4, and the transistor Q2. The speedometer gauge has no alarms that would require changing the back light color so the board has fewer components installed.

Referring now to FIG. 8, a tachometer circuit is shown. In this example, the same jumper is installed across the drain and source terminals of the transistor Q2 and the resistor R8 and diode D4 are omitted. As with the example FIG. 7, the white LEDs will always be biased on to provide white back light for the gauge. However, unlike the example of FIG. 7, the transistor Q1, resistors 802 (R6) and 804 (R7) are installed to provide bias current for the single red shift light LED D15. When the output pin-3 of the microcontroller 404 is high, the gate of the transistor Q1 is biased on and this allows the red LED D15 current to flow through current limiting resistor 506 (R17) and series diode 504 (D9) to the drain terminal of Q1 to ground (see FIG. 5). The shift light function allows the user to program a shift light turn on RPM value by touching the gauge face, actuating the touch sensor 630 (U5) in FIGS. 5 and 6 that is sensed at pin 4 input of microcontroller 404 (U2) in FIG. 8.

In one example, when the microcontroller 404 senses that the touch switch has been activated, the microcontroller function changes to reset the peak rpm dot of light on the indicia, it then displays the present shift light RPM value stored in EEPROM at parameter #4. If the touch switch is deactivated (e.g., the finger of a user is removed from the gauge face), then the shift light RPM value will turn off after about two seconds and the gauge will return to displaying the tachometer input RPM value on the display with the spinning light pointer. To reprogram the shift light value, the user may touch the gauge face and when the shift light arc is displayed momentarily remove the finger from the gauge face and again touch the gauge face. The shift light arc will begin moving, at first slowly, and then continue to increase in rate as the arc increases or decreases in value. To change the direction of the shift light arc, the user may momentarily remove their finger from the gauge face and again touch the gauge face and the arc direction changes to the opposite direction, moving slowly at first then increasing in speed after several seconds.

The gauges described herein may have several modes of operation that can be controlled by the user. If the user touches the gauge face and maintains the touch switch activation the sequence of events progress after several seconds. The sequence of modes progresses from reset peak RPM dot mode, display the present shift light RPM value mode, then after about 2 seconds has elapsed, the gauge enters the next mode or function, which is the cylinder count select mode by displaying a series of dots of light on the gauge face representing the selection by the user of 1, 2, 2-odd, 4, 6, 6-odd, or 8 cylinders.

If, while the cylinder count is being displayed, the user removes their finger from the gauge face and back on the face it will advance the cylinder count and the dot count on the gauge indicia. This action steps the cylinder count dot pattern each time the user touches and removes his finger for the gauge face. The dot pattern will repeat until which time the user keeps his finger off the gauge face for more than two seconds. In one approach, the last dot pattern displayed will be written to the parameter #30 in the parameter file of FIG. 15.

The dot patterns begin from the current stored value and progress through the dot pattern table that is referenced in more detail in the GUI full command set that is described elsewhere in this specification. The light dots are shifted to indicate the 2-odd and the 6-odd cylinder selection with all others evenly spaced around the gauge face indicia.

The gauge touch switch function may have still other sequences and modes of operation. For instance, if after the gauge has displayed the shift light rpm value and the cylinder count, and the switch is still activated, after another 2 seconds, the gauge may enter the DEMO mode of operation. When the DEMO mode is functioning, the gauge will automatically indicate an artificial arc of light representing the gauge input data that is increasing then decreasing moving from the zero indicia to the maximum indicia and repeating. Once the DEMO mode is selected, the gauge will continue to operate in this mode until power is turned off, which resets this mode. When the gauge enters the DEMO mode, the arc moves slowly up and down, but the user can program one of three speeds or slews of the light arc by again touching the gauge face; each time the gauge face is touched the speed of the arc will increase until the third speed is enabled, then the next touch will select the lowest arc speed with the speed selection repeating for each touch of the gauge face.

In FIG. 8, the circuitry accepts a low amplitude or high amplitude input signal representative of engine speed. This speed signal may be a signal of 0-5 volt amplitude such as the output of a vehicle engine control unit (ECU) or similar device such as an after market ignition control with a 0-12 volt amplitude. The same input terminal can also accept a high voltage signal representative of engine speed such as the ignition coil primary negative terminal. The ignition coil primary negative terminal voltage is near ground potential when the ignition coil is turned on to store energy in the primary winding.

Circuitry is provided for a single input that can determine what type of signal is present at the input TACH IN terminal and properly select and steer the signal to provide a clean and accurate tach-signal to the microcontroller 404 input at interrupt pin-17. The input signal is connected to a current limiting, high frequency filter consisting of components a resistor 806 (R27) (e.g., 36 ohms), filters 808 and 810 (FB2,FB3 of ferrite beads), capacitors 812 and 814 (C18 and C19, and, for example 220 pf/200 volt capacitors), and then connected to the two circuit paths for detection of high or low amplitude levels.

After the signal is applied to this filtering arrangement, the signal takes the low amplitude path by the bias current provided by resistors 816 and 818 (R25 and R26) to the anode of a diode 820 (D14), whose cathode is connected to the filter 808 to the input terminal. With an input signal of low amplitude, the signal drops to near ground at the TACH IN terminal which biases the anode of diode 820 (D14) to about 0.8 volts. When the anode of the diode 820 (D14) is at about 0.8 volts, the cathode of a diode 822 (D12) is about 0.1 volts and is input to a voltage comparator 824 (pin 4) via a resistor 826 (R21), (e.g., a 2K ohm resistor). The input signal is compared to the reference voltage by the divider resistor pair comprising a resistor 828 (R19) and a resistor 830 (R20), in this example, both 2K ohms, providing a reference voltage of 2.5VDC at the non inverting input of the comparator 824. The output of the comparator 824 (US) at pin 1 is high at this input signal level. The microcontroller 404 is configured to interrupt on the falling edge of the comparator signal at input pin 17 of the microcontroller 404. Also, microcontroller feedback to the comparator 824 is provided to the inverting comparator input pin 4 of the comparator 824 by series components a resistor 832 (R17) and a diode 834 (D7). With the tach-input signal low, the comparator output high, the feedback is set low at pin 11 of microcontroller 404 (U2). When the tach-input signal goes from low to high, or 0 volts to +5 volts at the tach-input terminal, the inverting input of the comparator 824 (U5) rises from the 0.1 volt bias to about 4.2 volts, causing the output of the comparator 824 to drop to O-volts, causing the microcontroller 404 to process an input interrupt by the falling input signal at pin 17 of the microcontroller 404. When the interrupt is processed the feedback output at pin 11 of the microcontroller 404 immediately goes high to +5 volts, providing an overriding positive bias of the comparator inverting input for about ¼ period of the tach-input signal.

This feed back can be used to override the signal that has any bounce or noise so that the comparator output does not bounce on the rising edge of the TACH IN signal. This feed back is also advantageous when the input is a high voltage coil primary type signal on the tach-input terminal. With the low amplitude input signal the Zener diodes 836 (D10) and 838 (D11) block any bias from the high voltage path to prevent the signal from biasing the clamp MOSFET transistor 840 (Q3) being activated.

With the TACH IN signal connected to an ignition coil primary terminal, the input signal will be a high voltage pulse at coil turn off of over 250 volts. The path of the input signal is routed differently and processed in a different manner. As the voltage at the TACH IN rises above the Zener reverse breakdown voltage of the series diodes 836 (D10) and 838 (D11), about 130 volts, current flows through current limiting resistor 842 (R23) (e.g., 10K ohm), and through a diode 844 (D9) to the gate of MOSFET transistor 840 (Q3) and a capacitor 846 (C17). The capacitor 846 (C17), in this example, a 0.22 uf capacitor, stores the bias voltage to keep the gate of transistor 840 (Q3) biased on for up to several hundred milliseconds, whose discharge rate is set by capacitor 846 (C17) and a resistor 848 (R24), (e.g., a 1M ohm resistor). This is about 220 milliseconds discharge time constant. With the transistor 840 (Q3) biased on the drain on the transistor 840 (Q3) clamps the bias from the resistor pair 816 (R25) and 818 (R26) to ground, preventing any bias from 816 (R25) and 818 (R26) from reaching the inverting input of the comparator 840 (U5).

The high voltage tach-input signal that biases the anode of diode 844 (D9) also biases the anode of a diode 850 (D8) that provides bias to the input of the comparator 840 inverting input via resistor 826 (R21). In this way, the comparator 840 receives the tach-input signal not from the DC bias current of the pull up resistor pair 816 and 818 (R25-R26) but directly from the voltage present at the TACH IN terminal. This voltage is clamped by a Zener diode 852 (D13) to 5.1 volts maximum before being applied to the comparator input pin 4. Likewise, the output of the comparator 840 changes from a high output level dropping to zero volts when the tach-input signal rises above the 2.5 volt reference at the comparator input pin 3. The falling edge of the output of the comparator 840 causes the microcontroller 404 to interrupt and process the input tach-signal. The output of the microcontroller 404 at feedback pin 11 goes high and maintains bias on the comparator 840 inverting input pin for about ¼ period of the tach-input signal.

The action of the feedback signal from the microcontroller 404 to the comparator 804 input when the input is a high voltage pulse may only exist for a small duration of time, in this example, 5-25 microseconds, but the feedback signal may override the comparator input effectively stretching the comparator signal to ¼ period of the tach-input signal. In this way, the tach-input signal is processed at a level with a much higher threshold, over 130 volts when the amplitude of the input signal is of high amplitude while being immune to noise on the coil terminal when the spark current ceases.

The transistor 840 (Q3) remains biased on during high amplitude input operation because of the long discharge time constant of the capacitor 846 (C17) so that only the path of the signal is selected for the high voltage tach-input signal. The small capacitor 854 (C16), in this example, a 0.001 microfarad capacitor, provides minimum filtering at the input of the inverting pin of the voltage comparator, which only causes about 1-2 microsecond of delay on the rising edge of the tach-input signal. A resistor 856 (R22), in this example, a 47K ohm resistor, discharges the capacitor 854 (C16) after the feedback signal goes low at the end of the ¼ period duration in about 100-microsceonds.

Referring again to FIG. 7, the tach-input circuitry is modified from that of FIG. 8 where the input signal is very low amplitude from a magnetic pickup to send a vehicle speed signal to the gauge for speed and distance measurement. The same comparator arrangement is used, but with some values changed to lower the reference voltage to about 0.9 volts at pin 3 of the comparator 824 (U5). Also the comparator hysteresis resistor 858 (R18) is increased to 47K ohms. The tach-input is routed directly to the comparator inverting input via jumper JP1 from the input resistor 806 (R27), a 1K ohm at the tach-input terminal. All of the high voltage circuitry is not required in this application so those components not required for a speedometer gauge application are marked “NONE” in FIG. 7.

When the gauge is configured for a speedometer/odometer, parameter #19 is set to a value of 5 to indicate the speedometer display, and parameter #31 is used to program the microcontroller 404 to generate clock pulses per 1/10 mile for the odometer clock rate of the microcontroller output at pin 6 of the microcontroller 404.

The microcontroller output biases the base of transistor 624 (Q2) in FIG. 5 to clock the odometer LCD counter 626 input for every 1/10 mile the vehicle travels. The resistor 628 (R15) pulls the clock input pin of the LCD counter 626 to +12 volts, and the transistor 624 (Q2) pulls the clock pin to ground. In FIG. 7, the resistor 702 (R9), in this example, a 10 k ohm resistor, is required to bias the transistor 624 (Q2) on during power up of the microcontroller to prevent an erroneous clock during turn on of the gauge. After power up, the microcontroller 404 is in a normally high output state and will pulse low for about 12.5 ms, each 1/10 mile traveled.

The speedometer/odometer gauge of FIG. 7 and FIG. 5 also allows the user to calibrate the speedometer/odometer to the transmission pulse signal generator connected to the TACH IN terminal of the gauge. In one example, to calibrate the gauge, the user drives the vehicle over a marked distance of 1 mile. To begin the calibration sequence, the user may turn the power on to the speedometer and touch the gauge face until the pointer LED displays three dots near zero MPH, indicating it is ready to enter the calibration mode. To enter the calibration mode, the user may momentarily remove their finger from the gauge face and each time the face is touched again, the dots will decrement from 3-to-2 to-1 to none indicating calibration mode is activated and will begin capturing the number of pulses in 1 mile of vehicle travel. After the vehicle has traveled 1 mile, the vehicle is stopped and again the gauge face is touched until the three dots appear. Likewise the user touches, releases, then touches the gauge until all of the dots are gone indicating the gauge has been calibrated to the vehicle. The gauge is then ready for operation to display speed and distance traveled. In this example, the microcontroller 404 captures the total number of pulses and divides the number by 10 to increment the odometer LCD counter. The 1/10 mile pulse count is stored in parameter #31. Parameter #31 will, in one example, be a value of 1000 to 10,000, with a range of 1 to 65,536 pulses per 1/10 mile. The rate of the input pulse frequency is calculated by the microcontroller 404 to drive the light pointer to indicate miles per hour speed or kilometers per hour or any other rate measurement desired. In one approach, during the calibration mode the clock to the odometer is disabled to prevent erroneous incrementing of the LCD counter.

Referring now to FIG. 9, a schematic for the light pointer printed circuit board (PCB) or other carrier member is described. The light pointer PCB (or carrier member) contains the secondary rotary transformer winding 902, LED 904 at the tip of the PCB, full wave bridge rectifier 906, current limiting resistor 908 and filter capacitor 910.

The light pointer PCB may take a variety of forms. For example, it can have one or more LEDs. These LEDs can be of a variety of colors to suit the needs of the gauge or user. The shape and dimensions of the board may vary or the board itself may be replaced with another element (e.g., a light pipe) that performs the same or similar functions.

The rotary transformer primary is magnetically coupled to the pointer secondary winding that is mounted on the pointer PCB, which is mounted to the motor shaft. When the driver turns on via the gated clock oscillator 620 (X1) in FIGS. 5 and 6, it provides a high frequency clock to the inverting and non-inverting driver inputs of oscillator 618 (U2). The outputs of the driver 618 (U2) are connected to the transformer primary through a current limiting resistor 640 (R10), a 47 ohm resistor, and a capacitor 642 (C6), a 220 pF capacitor.

The capacitor 642 (C6) performs functions to tune the transformer to near resonate-frequency so that the maximum peak-to-peak voltage is generated across the primary and secondary windings, and also to block DC current flow when the clock is stopped and the driver outputs are in a steady output level state. The AC voltage generated across the transformer secondary on the pointer PCB is rectified to DC level by the two dual Schottky diodes D2 and D3, which form a full wave bridge rectifier 906. The voltage at the output of the diode bridge is, for instance, about 9 vdc at maximum intensity and drives the LED 904 (D1) with about 30 milliamps, limited by resistor 908 (R1), for example, a 240-150 ohm resistor. The clock frequency is preferably at least 2 MHz to 4 MHz, which is 3.68 MHz in the examples of FIGS. 5 and 6 so that the drive current to the pointer LED 904 is low ripple and capable of very fast rise and fall times.

The LED 904 can be turned on and off in about 150 nanoseconds due to the fast turn on/off of the clock oscillator 620 (X1) and the small filter capacitor 910 (C1), a 0.001 microfarad capacitor. The 3.68 MHz clock frequency allows the magnetic components to be kept very small while maintaining high efficiency.

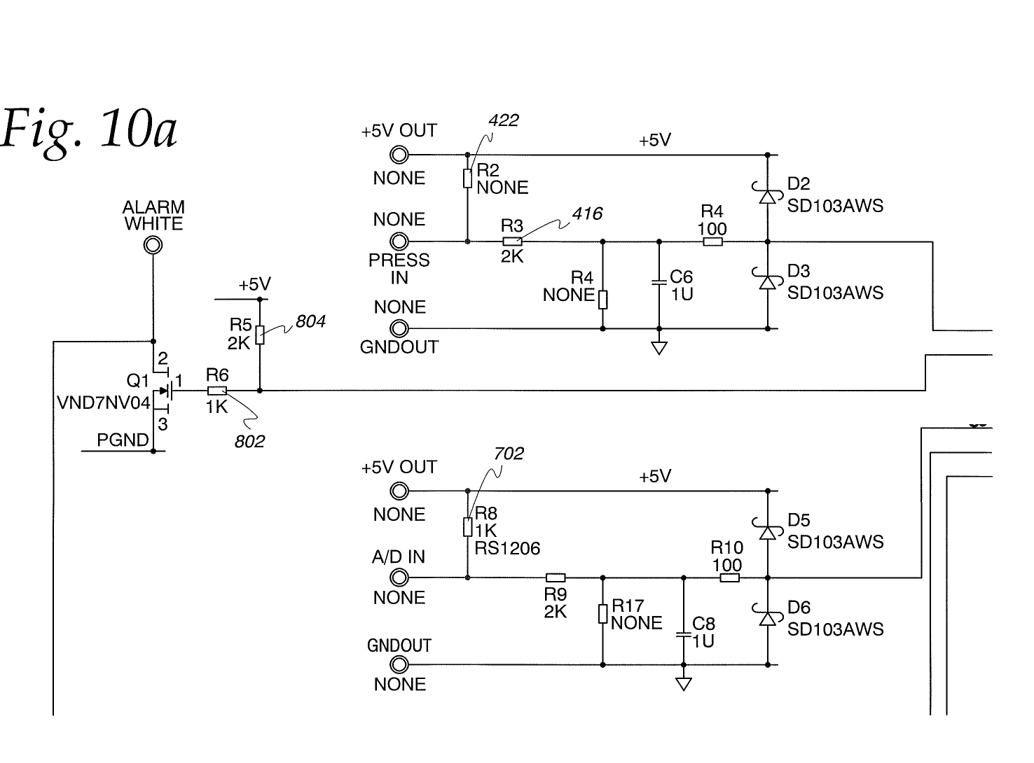

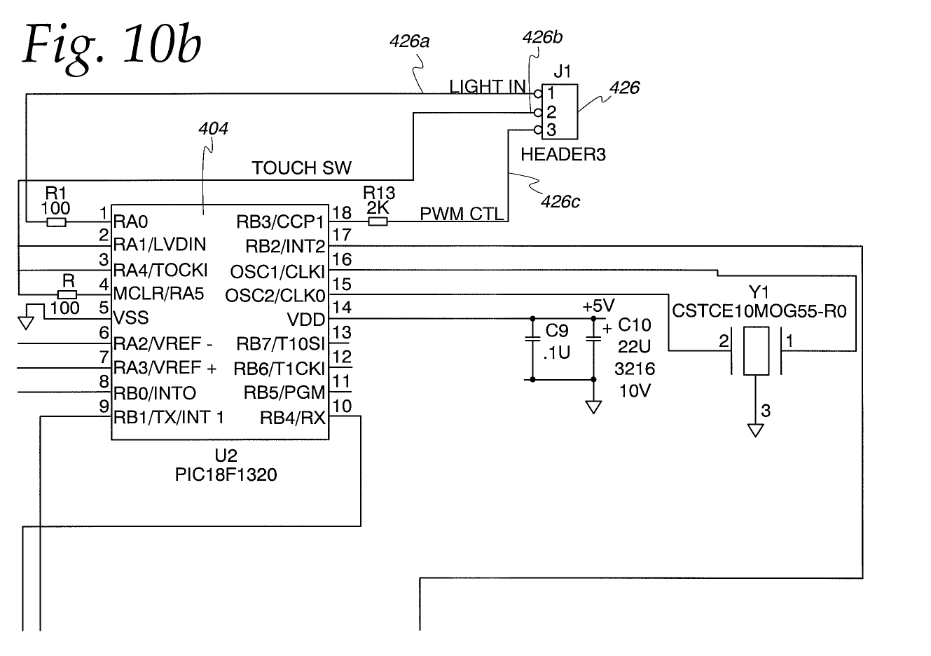

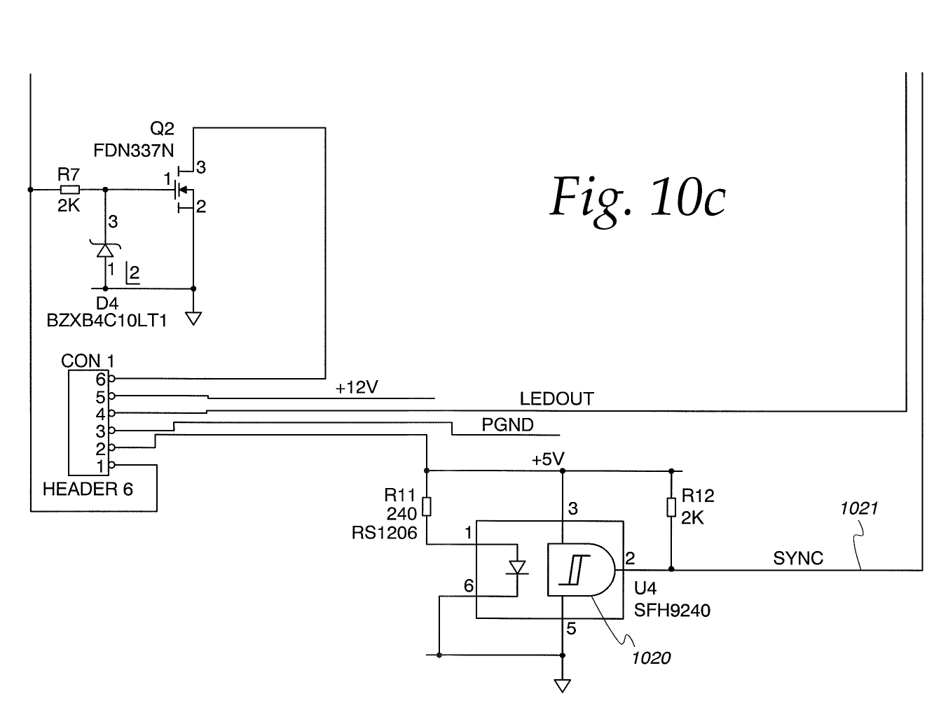

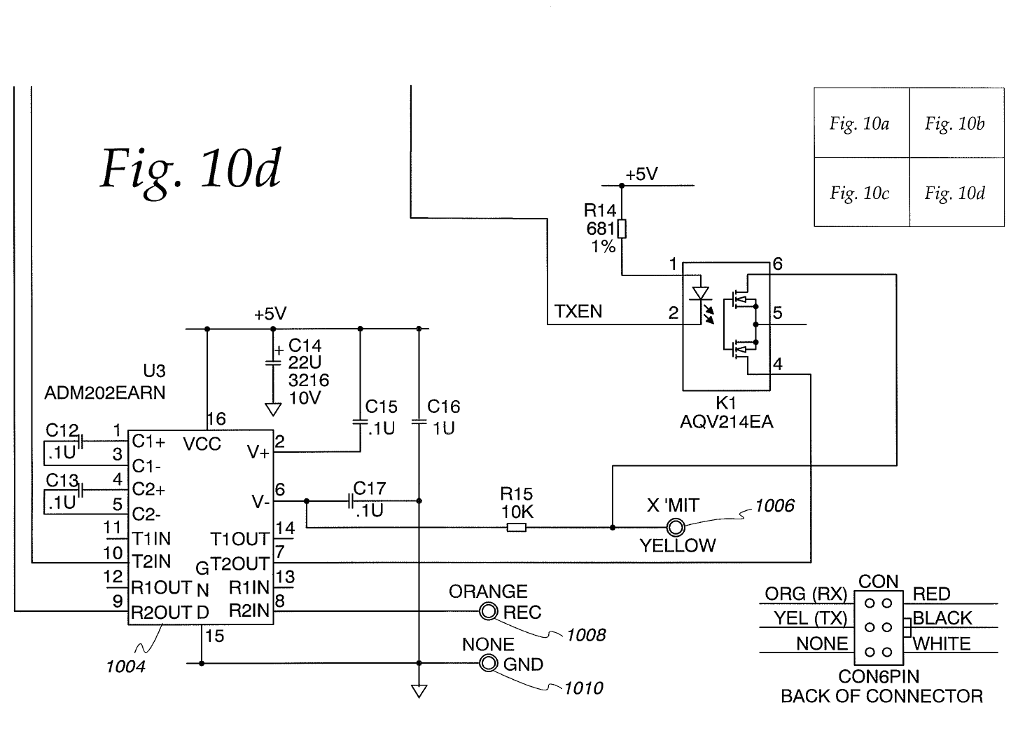

Another aspect of the present approaches is seen in FIG. 10, which includes an optical isolated switch 1002 (K1), such as a AQV214EA from Panasonic Corporation. The switch 1002 (K1) is connected from the transmit output pin of chip 1004 (U3), an RS232 IC to the output connector. The connector is also connected to ground and to the RS232 receive input pin. This topology allows up to 20 gauges to be connected to a serial RS232 communications bus to communicate with another control device. The signal TXEN (input of switch 1002) goes low to allow a single gauge to connect to the PC or control box to transmit data, one gauge at a time.

A reflective opto switch 1020 (U4) in FIGS. 4, 7, 8, and 10 is a device such as a SFH9240 device from OSRAM. The opto switch 1020 (U4) illuminates the bottom of the motor can, which is painted black with a single white stripe that will reflect the light from the LED of the reflective opto switch 1020 (U4) and reflect into the photo receiver section of the switch 1020 biasing the switch 1020 on. When the photo receiver is biased on, the output signal SYNC 1021 goes low, and is input into the input pin 8 of the microcontroller 404 (U2). The low going edge of the SYNC signal 1021 causes the interrupt of the microcontroller 404 to process this edge to measure the speed of the motor and the position of the motor/light pointer. The SYNC signal is used for calculating when the light pointer should be turned on and the time of one revolution of the motor. Since the microcontroller 404 has measured the motor revolution time, the microcontroller 404 can now control the on/off operation of the light pointer, for example, within one part of 65535 timer counts. Since the microcontroller 404 knows the position of the light pointer, the microcontroller 404 can then be programmed to synchronize the decal graphics to the light pointer. The parameter #1 allows the rotation of the beginning and ending of the arc of light displayed for alignment of the decal indicia.

In one approach, a control box is coupled to the communication bus and multiple gauges are connected to the communication bus. The control box may, in one approach, be a central controller for the vehicle that is coupled to a variety of gauges via the communication bus. In one approach, the control box sends a serial broadcast data message every predetermined time period, for example, every 20 ms, containing measurement information from all of the gauges.

Thereafter, all of the remote gauges receive the message and utilize only the information they need. In one approach, a buffer at the gauge may receive the data and only gauge selected data is stored in the gauge microcontroller buffer, not the entire message received.

In order to receive data broadcast by the communication bus, each gauge has an assigned monitor select (parameter #9), which indicates a time slot on which data intended for a particular gauge is located. Also, each gauge can be assigned a Submux Select parameter (parameter #10) that indicates a sub-slot within the time slot. For example, an engine with 8 exhaust gas temperature sensors could have a monitor number of 2 (i.e., parameter #9=2), and a Submux Select value that ranges from 0-7 (i.e., parameter 10 ranges from 0 to 7). In other words, in this example 8 gauges select monitor item 2 and each is assigned a different Submux Select value for each cylinder in the range of 0-7.

Each gauge may display one or more data values according to the configuration parameters assigned in EEPROM. For a gauge configured to display four data types, each information type (e.g., types A, B, C, D) has a unique monitor number (i.e., parameter #9) and each could have a submux value (i.e., parameter #10). In an alternate approach, the gauge could be configured for four data items displayed with four unique monitor numbers (i.e., four unique values of parameter #9) with no Submux Select values.

Parameter #5 is used to select a broadcast time slot for the gauge to send back data to the control box when the data is edited with the touch switch function. Parameter #5 identifies the slot number of the gauge sending data over the TX output of the RS232 corn bus. In one example, only one gauge may be transmitting valid data back to the control box at a time.

Thus, using the present approaches, the light pointers described herein can be configured to display one or more data items as one or more arcs of light on a single gauge. For instance, from the inputs of FIG. 4, three data items could be displayed, specifically, exhaust gas temperature from the SPI input, pressure from the PRESS IN analog input and a third analog data from the A/D IN input terminal. The gauges can be configured to display these data items in one or more arcs of selectable sizes, direction and illustrate features by flashing the arcs of light to indicate functions such as open thermocouple from the SPI amplifier, over-pressure, under-pressure, as well as changing the back light from the normal white to red to indicate a warning or alarm condition. The alarm modes for each gauge are configured in parameter 26.

As mentioned, the parameters of each data displayed are configured in EEPROM, which is part of the microcontroller. In the present approaches, with the use of a graphical user interface (GUI), the user or manufacturer can set any of the gauge parameters that affect the display of one or more independent information sources. The gauge pointer calibration or alignment of the light pointer to the gauge face indicia may be performed using the GUI at the time of manufacture. In addition, the system may be programmed during manufacturing to allow the user to program only some parameters. Alternatively, the user may be allowed to program all parameters.

In one example, the light pointer only need be positioned on the motor shaft within about 10-degrees accuracy of the proper indexed position relative to the motor sync position (which, in one example, is a white stripe on the motor housing that generates the sync position signal to the microcontroller for both speed and position of the motor and light pointer). After the gauge is assembled, the pointer position is set to align the light pointer with the ends of the gauge face indicia, for instance, at the zero and full value positions by a dot of light being displayed by the light pointer at minimum, maximum and ½ scale. A technician then, using the GUI, can move the light pointer to align the dots of light to the gauge face indicia. This calibration data is immediately written to EEPROM which is retained after power is removed from the gauge. The configuration data is read directly from EEPROM during program execution.

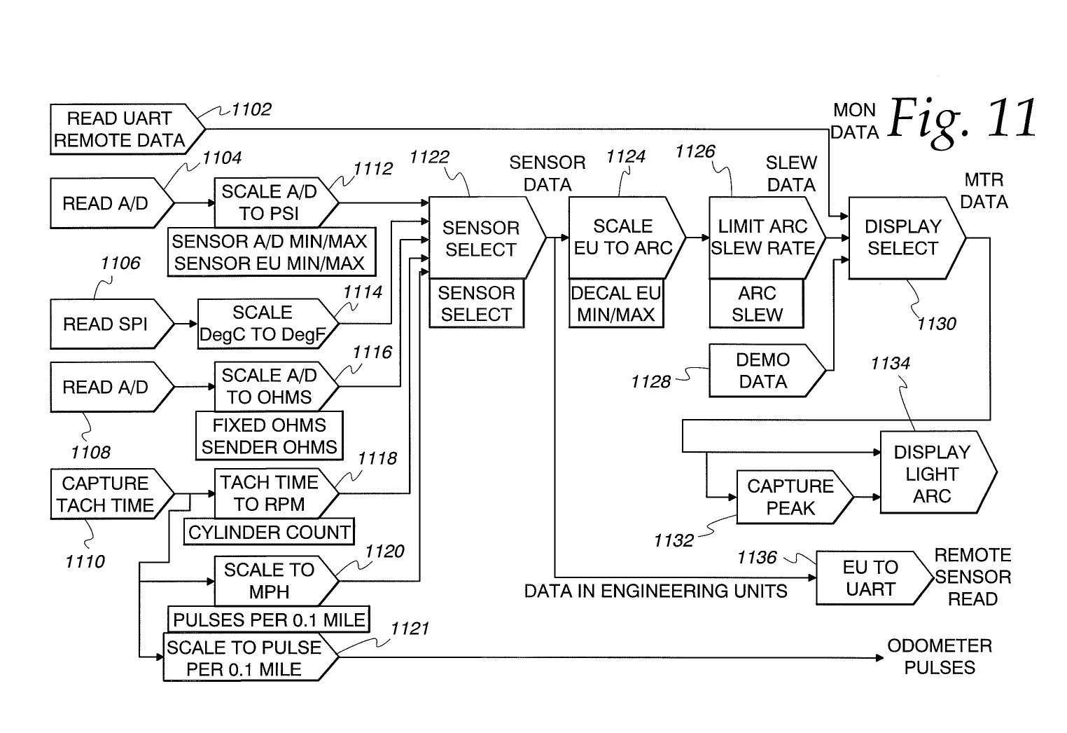

Referring now to FIG. 11, a flow chart of gauge data as controlled by the system software of the present approaches is described. As shown, the gauge software captures the raw data from one of the external data sources; selects the raw data from that data source; converts the raw data to engineering units (e.g., RPM, psi, or degrees); converts the engineering units data to arc unit data; limits the slew rate of the arc unit data; converts the arc unit data to timer count units; and uses the timer count units to control the on/off times of the arc of light. The one or more arcs of light are then presented on the visual display (e.g., a lens) of the gauge.

Specifically, at step 1102, UART data is read. For example, the UART data may be received over a communication bus and may be from a UART that obtains information from a personal computer or from other engine controllers. At step 1104, analog data is read from an analog device. For example, this information may be pressure data from a pressure sensor. At step 1106 temperature data is read from a temperature sensor. At step 1108, other analog data is read from other analog devices, in this example, resistance units from a fuel level gauge. At step 1110, engine speed data is read from an engine speed sensor. It will be appreciated that additional or different sources of information from different types of sensors or gauges may also be obtained.

At step 1112, the pressure data obtained at step 1104 is scaled to pounds per square inch (psi) units. At step 1114, the temperature data obtained at step 1106 is scaled to degrees Fahrenheit. At step 1116, the resistance data obtained at step 1108 is scaled to units of ohms. At step 1118, the raw speed data obtained at step 1108 is scaled to revolutions per minute (rpm). At step 1120, the raw speed data obtained at step 1108 is scaled to miles per hour and, at step 1121, is also scaled to pulses per 0.1 miles. All of the above-mentioned information is received at the gauge for potential display (depending upon a user selection) as one or more arcs of light on the face of the gauge.

At step 1122, particular sensor data is selected to be displayed. In one example, the user may determine they may only want to display one or two types of information for a particular application. For instance, the user may initially wish to display RPM data and pressure data. Later, the user may wish to display RPM and temperature data. Still later, the user may wish to display RPM data, temperature data, and pressure data. Alternatively, the system may automatically determine the type of data to be displayed. In still another example, the type of data may be set by the gauge manufacturer.

At step 1124, the sensor data is converted from engineering units to arc units. With this step, the engineering units-based data is converted into units that can be displayed on the face of the gauge (i.e., arc units). At step 1126, the arc slew rate is limited. In this step, the rate at which the arcs grow from 0 to a full range value is set. In some applications where the quick display of information is required (e.g., drag racing) a high slew rate may be selected while in other applications a slower slew rate may be selected (e.g., for consumer use).

At step 1128, demo data is received. This data may be factory set to illustrate the features of the device for users. At step 1130, a particular display (with particular types of information to display) is selected. This step converts the arc unit data to timer count units. At step 1132, the peak value of the selected display data is captured. For example, the peak engine RPM is constantly being stored and displayed also as a dot of light at the peak engine RPM on the display.

At step 1134, the light arc or arcs are displayed on the gauge. This step uses the timer count units to control the on/off times of the light pointer. The one or more arcs of light become the visual display of the gauge data. At step 1136, feedback to the UART may be provided when the engineering units are converted to UART units and sent to a remote sensor or device.

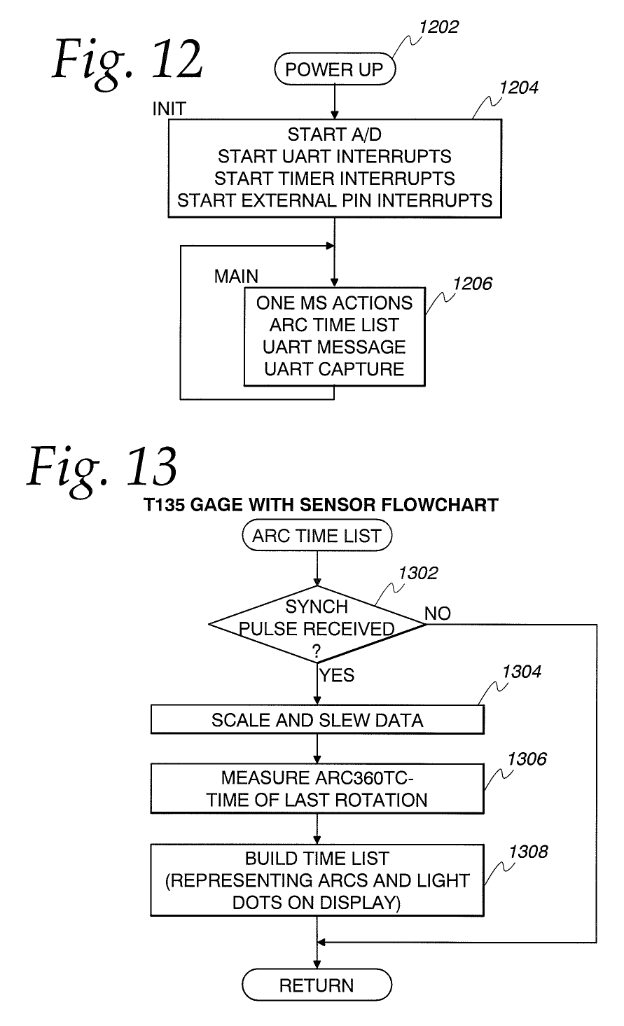

One example of the main control flowchart for the software executed by the microcontrollers described herein is shown in FIG. 12. The software illustrated in FIG. 12 can be executed by any of the circuits of FIGS. 4-10 to implement the functions illustrated described with respect to FIG. 11. However, it will be understood that the exact procedures, number of procedures, and the functions of the procedures shown in FIG. 12 can vary depending upon the needs of the user and the system.

After power on of the gauge at step 1202, the control software initializes the processor in order to provide gauge control. The control software then repeats the main loop over and over until power is removed. At step 1204, several initialization routines are performed (Start A/D, Start UART interrupts, Start Timer Interrupts, Start External Pin Interrupts). These routines initialize these interrupts that are received by the processor. These interrupts are, for instance, used to determine motor position, indicate the receipt of data on the communication bus, and receipt of data from analog devices. At step 1206, the routines OneMsActions, ArcTimeList, UARTMessage, and UARTCapture are executed. The functions of these routines are described in detail below. After the initial execution of step 1206, execution of these routines is repeated until power is removed from the system.

The OneMS Actions routine is used to pace the slower, timed actions of the system. For example, actions are performed to set the timer, debounce the touch switch and read the analog inputs. As illustrated, these actions are only repeated once per millisecond. Although the actions occur, in this example, every one millisecond, it will be understood that other timing values can be used.

Referring now to FIG. 13, the ArcTimeList routine is described in detail. This routine processes the data flow from the sensor input to the arc (or arcs) of light output. At step 1302, a new cycle begins once per revolution with the testing for a sync pulse from the motor. Once the signal is received, the display of the arc or arcs of light is synchronized with motor position. At step 1304, data from the selected inputs of the gauge is scaled and slewed for one or more arcs of light to be displayed on the gauge. At step 1306, a time (Arc360Tc) is measured. This value is the measured time of the last 360 degree revolution of the arc of light. At step 1308, the measured time along with the slew data from the selected inputs is used to build a sequence of timer counts (stored in a TimeList data structure). More specifically, TimeList is a list of counts representing times or time periods that is used to turn the arc of light off and on to display the one or more arcs of light. TimeList may be any type of data structure used to store rotation times. When a particular value in TimeList is reached (or a period expires), the LEDs on the light pointer may be activated or deactivated as appropriate.

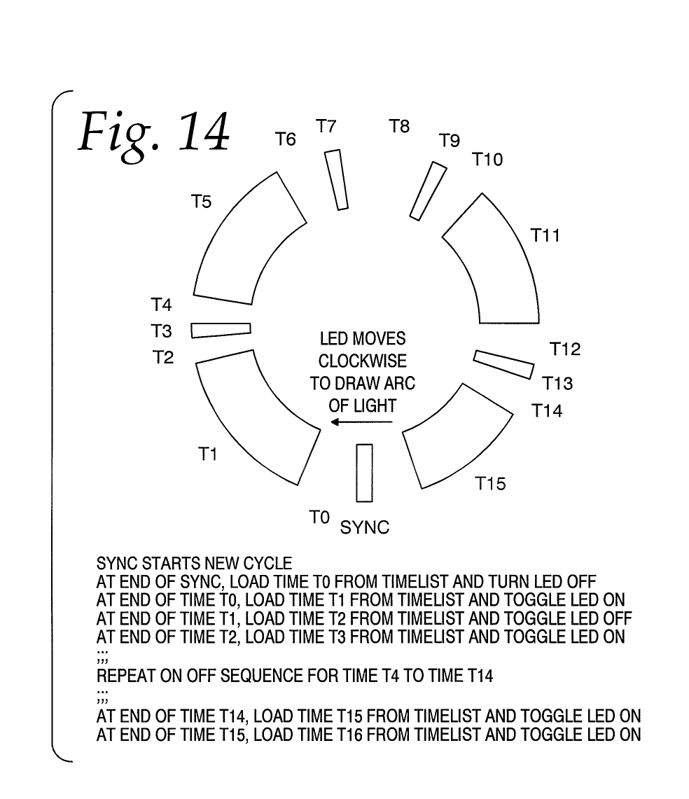

Referring now to FIG. 14, an example of using the information in the TimeList data structure to turn the arc of light off and on is described. In this example, four informational sources (e.g., from four sensors) are displayed. In FIG. 14, it is assumed that the light pointer is rotating in the clockwise direction about the gauge. The pointer position then crosses over the sync detector causing a sync interrupt signal to be produced that initiates the display of the one or more arcs of light. An LED on the light pointer is activated and deactivated and starts a timing sequence of light off, light on, light off, light on, and so forth. The timing sequence that activates and deactivates the LED on the light pointer is controlled by the values in the TimeList. In this example, the result is a display of four types of information (i.e., meter values as arcs of light) and four peak values (dots of light) on the face of the gauge.

As shown in FIG. 14, Time T1 is when data from a first informational source is displayed. Time T3 is used to display a peak value of the first informational source. Time T5 is used to display data from a second informational source and Time T7 is used to display the peak value for this source. Time T9 is used to display the peak value for a third informational source and Time TI1 is used to display the data from this third informational source. Time T13 is used to display the peak value for a fourth informational source and Time T15 is used to display the data from this fourth informational source.

More specifically, the LED on the light pointer is deactivated at the beginning of the synch period as the pointer rotates in the clockwise direction. During the period T0, the LED remains off to allow the TimeList and the time T1 is loaded from memory. The LED is activated for the time T1 to produce an arc of light. At the end of T1, the time T2 is loaded and the LED is deactivated for the time period T2 at which time the time T3 is loaded and the LED is activated. This process continues for the remaining times shown in FIG. 14 to produce the arcs of light (and peak dot values) as shown. It will be understood that the number and positioning of the arcs may be varied from the examples that are shown in FIG. 14.

The display of light by the arc can take many forms and in one example the arc or arcs of light is displayed similarly to a comet tail. In this example, the head of the comet represents the sensor value. The length of the comet tail represents the recent changes of the sensor value. The history of a last predetermined number of samples can be used to calculate the length of the tail.

As previously described, different commands are used by the system to perform different functions. The source of the commands can vary. In one example, the user or devices can send commands (Zcmds) to the gauge. In another example, various devices can automatically generate the commands. A combination of these approaches can also be used.

The various commands described below can be utilized by a user or employed during manufacturing to set or configure various gauge parameters and well as perform other functions. For example, the commands can calibrate the arcs of light with the decals physically present on the display, set alarm limits (both low and high values), read parameters from the gauge, and/or write (i.e., set) parameters in the gauge. Other examples of functions can also be performed. The commands can be input using a variety of approaches utilizing the GUI, for instance, by typing the command, using touch screen or touch buttons, or any other approach to input data. In the following example, each numbered command has an associated number parameter. For instance, ZCmd1 has a parameter ArcBegin Calibration, which is parameter #1. Furthermore, it will be understood that the following commands are only representative of the variety of commands that are possible utilizing the present approaches and that other commands and parameters can be used based upon the needs of the system or the user.

The command (ZCmd 1, ArcBegin Calibration) is a read/write command. ArcBegin calibration is used to align the zero of the first informational stream (meter)(to be displayed) with the physical decal zero actually on the gauge. In one example, an edit of the ArcBegin Calibration value causes the gauge to display two alignment dots on the face of the gauge. The first dot is aligned over the decal start and the last dot is aligned over the decal end. In one example, the range of ArcBegin Calibration is from 0 to 65535. Other ranges are possible.

The command (ZCmd 2, Arc Begin End Calibrate Size) is a read/write command. The value of ArcBegin Calibrate Size represents the size of an arc in degrees. The range of this parameter, in one example, is 0 to 360 degrees.

The command (ZCmd 3, Low Alarm) is a read/write command. The Low Alarm is the alarm lower limit trip point and can be changed using this command. In one example, the serial range is 0 to 65535 (gauge arc full scale).

The command (ZCmd 4, High Alarm) is a read/write command. High Alarm is the alarm upper limit trip point and can be adjusted using this command. The serial range 0 to 65535 (gauge arc full scale).

The command (ZCmd 5, Monitor Select) is a read/write command. Monitor Select selects the broadcast time slot to return data to an outside entity such as a control box. The range of values for Monitor Select is 1 to 20 time slots.

The command (ZCmd 6, Gauge Type) is a read/write command. The Gauge type selects the decal used for each gauge. This value is not used by the gauge and is used for documentation purposes only.

The command (ZCmd 7, Sensor A/D Min) is a read/write command. The command can be used to adjust Sensor A/D Min, in one example, a 16-bit value. The value is used to convert the raw Sensor A/D value into the proper engineering units. For example, Min A/D value can range from 0.5 volts (Sensor A/D Min=6553) to 5 volts (Sensor A/D Min=65535).

The command (ZCmd 8, Sensor A/D Max) is a read/write command. The command can be used to adjust Sensor A/D Max, in one example, a 16-bit value. The value of Sensor A/D Max is used to convert the raw A/D value into the proper engineering units. For example, a value of 4.5 volts can be represented by setting Sensor A/D Max to 58982 and a value of 5 volts can be represented with a Sensor A/D Max of 65535.

The command (ZCmd 9, SubMux Period) is a read/write command. The command can be used to set SubMux Period and thereby select the time slot of the subMux broadcast to receive data. For example, when the SubMux Period is 2 periods for the gauge, then two sets of gauge data share the time slot used by this gauge.

The command (ZCmd 10, SubMux Select) is a read/write command. SubMux Select identifies the broadcast data to capture. For example, this identifier may have a value of 0-7 to represent one of eight temperature sensors each having a unique identifier (i.e., 0-7).

The command (ZCmd 11, Sensor Data in Engineering units (Psi, DegF, Rpm)) is a read command that reads a sensor value. In one example, SensorData=300 for 30.0 psi.

The command (ZCmd 12, Sensor Eng Min) is a read/write command. Sensor Eng Min is a 16-bit value that is used to convert the A/D value into engineering units. For example, Sensor Eng Min is set to 0 for a 0 to 30.0 psi sensor.

The command (ZCmd 13, Sensor Eng Max) is a read/write command. Sensor Eng Max is a 16-bit value that is used to convert the analog value into engineering units. For example, Sensor Eng Max can be set to 300 for 0 to a 30.0 psi sensor.

The command (ZCmd 14, Sensor Decal Min) is a read/write command and is the value in engineering units for start of decal arc. For example, Sensor Decal Min is set to 0 for a 0 to 30.0 psi decal.

The command (ZCmd 15, Sensor Decal Max) is a read/write command and is the value in engineering units for end of decal arc. For example, Sensor Decal Max is set to 300 for a 0 to a 30.0 psi decal.

The command (ZCmd 16, Min Intensity) is a read/write command. Min Intensity ranges from 0 to 255 (0 being dim, 255 being bright) and sets the minimum intensity of the arcs of light. In addition, the command (ZCmd 17, Max Intensity) is a read/write command that sets the maximum intensity. Max Intensity ranges from 0 to 255 (0 being dim and 255 being bright).

The command (ZCmd 18, Arc Slew Rate) is a read/write command that sets the values the arcs will be slewed to full scale. The Arc Slew Rate ranges from 0 to 65535. The formula (65536*12.5/Arc Slew Rate) can be used to calculate the slew time to fill scale in milliseconds. For example, using this formula, an Arc Slew Rate of 0 means that Arc Slew is off (i.e., 0). An Arc Slew Rate of 1 gives 819 seconds to full scale (14 minutes). An Arc Slew Rate 10 gives 82 seconds to full scale. In addition, an Arc Slew Rate 100 gives 8 seconds to full scale. Also, an Arc Slew Rate of 1000 gives 0.82 seconds to full scale and an Arc Slew Rate 10000 gives 0.08 sec to full scale.

The command (ZCmd 19, Sensor Type) is a read/write command that allows a user to indicate a sensor type that is coupled to the gauge. For example, Sensor Type 0 represents a situation where no sensor is coupled to the gauge. Sensor Type 1 indicates that an A/D sensor with Min/Max Scale is coupled to the gauge and Sensor Type 2 indicates that an A/D sensor with an Ohm Scale is coupled. Sensor Type 3 represents that an Spi sensor with DegC to DegF Scale is coupled while Sensor Type 4 indicates that a tachometer with an Rpm Scale is coupled. Sensor Type 5 represents a tachometer with a Mph Scale is coupled.

The command (ZCmd 20, Sensor Channel) is a read/write command that indicates a particular channel for a sensor. Sensor Channel has a range of 0 to 7. For example, a Sensor Channel is set to 0 for a sensor connected to A/D channel 0.

The command (ZCmd 21, Meter Arc Size) is a read/write command that indicates the size of an arc for a particular information stream (e.g., pressure, temperature, fuel level). Meter Arc Size ranges from 0 to 65535 (65536=360 degrees). For example, 180 degrees is represented by 32768.

The command (ZCmd 22, Meter Arc Direction) is a read/write command that is used to set the direction of arc movement or growth. For example, the value is set to 0 to cause clockwise movement and 1 is used to cause counterclockwise arc movement.

The command (ZCmd 23, Auto Zero Arc) is a read/write command used to set the peak pointer of the arc. For example, 0 is for off; 1 is used to indicate an Auto Zero Arc during gauge power on; 2 is for no peak pointer on gauge; and 3 is used for both 1 and 2.

The command (ZCmd 24, AfterSize) is a read/write command. This command adds unused space after the ArcSize of a meter. In one example, AfterSize has range of 0 to 65535 (e.g., 65536=360 degrees).

The command (ZCmd 25, Touch Switch direction) is a read/write command that is used to indicate that two types of touch switches can be installed during mfg of gauge. 0 is used for one type and 1 for the other type.

The command (ZCmd 26, Alarm Edit Enable) is a read/write command that is used to set the ability of a user to edit alarm parameters and other alarm features related to the arcs during alarms. For example, a value of 0 is used for low/high alarm edit disable (set to disable the ability of a user to edit an alarm function) and flashing arc during an alarm display. A value of 1 is used for low alarm edit enable and flashing arc during an alarm. In addition, a value of 2 is used for high alarm edit enable and flashing arc during an alarm. A value of 3 may be used for low/high alarm edit enable and flashing the arc during an alarm. The value of 4 can be used for low/high alarm edit disable and not flashing the arc during an alarm. The value of 5 may be used for low alarm edit enable and not flashing the arc during an alarm. The value of 6 can be used for high alarm edit enable and not flashing the arc during an alarm. The value of 7 may be used for low/high alarm edit enable and not flashing the arc during an alarm. The value of 8 can be used for low/high alarm edit disable and no alarm LED flashing the arc during the alarm. The value of 9 may be used for low alarm edit enable and no alarm LED or flashing the arc during an alarm. The value of 10 can be used for high alarm edit enable and no alarm LED or flashing the arc during an alarm. The value of 11 may be used for low/high edit enable and no alarm LED or flashing the arc during an alarm.

The Touch Switch on the face of the gauge is used for user edits. The edits that can be enabled for each meter are listed in zCmd 26 and zCmd 27. In one example, when the Touch Switch is pressed, the arc of light will display the first enabled edit. Continuing to hold the touch switch for more than one second will display the next enabled edit.

In one example, the order of the edits is Low Alarm for Meter A, High Alarm for Meter A, Low Alarm for Meter B, High Alarm for Meter B, Low Alarm for Meter C, High Alarm for Meter C, Low Alarm for Meter D, High Alarm for Meter D, Empty, Air Filter Peak, Pulses Per Mile, or CylCnt for Meter A, Full for Meter A, Empty, Air Filter Peak, Pulses Per Mile, or CylCnt for Meter B, Full for Meter B, Empty, Air Filter Peak, Pulse Per Mile, or CylCnt for Meter C, Full for Meter C, Empty, Air Filter Peak, Pulses Per Mile, or CylCnt for Meter D, Demo Data, and Restore factory defaults. In one approach, the Arc TimeList is no longer used for meter data or for meter peaks. Instead, the Arc TimeList is now loaded with edit alarm values or the edit mode dot patterns for one selected meter.

The command (ZCmd 27, EmptyFull Edit Enable) is a read/write command that is used to enable the ability of the user to edit certain functions/parameters. The value 0 indicates Empty/Full edit disable and the value 1 indicates Empty edit enable. The value 2 indicates Full edit enable and the value 3 indicates Empty/Full edit enable. The value 4 indicates Air Filter Peak edit enable and the value 5 indicates Pulses per Mile edit enable. The value 6 indicates Tach Cycle Count edit enable. The value 7 indicates Arc Tail enable.

The command (ZCmd 28, Gauge Sensor Board select) is a read/write command and is used to select the Sensor board Part Number. The command (ZCmd 29, Gauge Software revision) is a command that reads the Revision number and displays this number to the user.

The command (ZCmd 30, Tach Cylinder Count) is a read/write command and is used to set the cylinder count. In one example, the value 0 is used to indicate 1 cycle. The value 1 is used to indicate 2 cycles The value 2 is used to indicate 2 cycles and odd firing. The value 3 is used to indicate 4 cycles. The value 4 is used to indicate 6 cycles. The value 5 is used to indicate 6 cycles with odd firing. The value 6 is used to indicate 8 cycles. In odd firing, the sparks are not evenly spaced. Odd numbered sparks are offset from even spacing and the odd fire input can be corrected by reading pairs of inputs.

The command (ZCmd 31, Pulse Per Tenth Mile) is a read/write command that is used to indicate the Mph scale. In one example, the value for Pulse Per Tenth Mile is 10,000.

The command (ZCmd 32, Fixed Ohms) is a read/write command. It can be used for Fuel Gauges or with Sensor Type set to “A/D ohm scale.” In one example, a value of 70 is used.

The command (ZCmd 33, Special Functions) is a read/write command that may be used to set special functions of the gauge. The value 0 is used to indicate that no special functions will be used. The value 1 is used to indicate the first meter (Information stream or source) of a slew lock group. The value 2 is used to indicate the last meter of a slew lock group. The value 3 is used to skip a meter when the meter input is full scale or skip the next meter when this meter's input is not full scale.

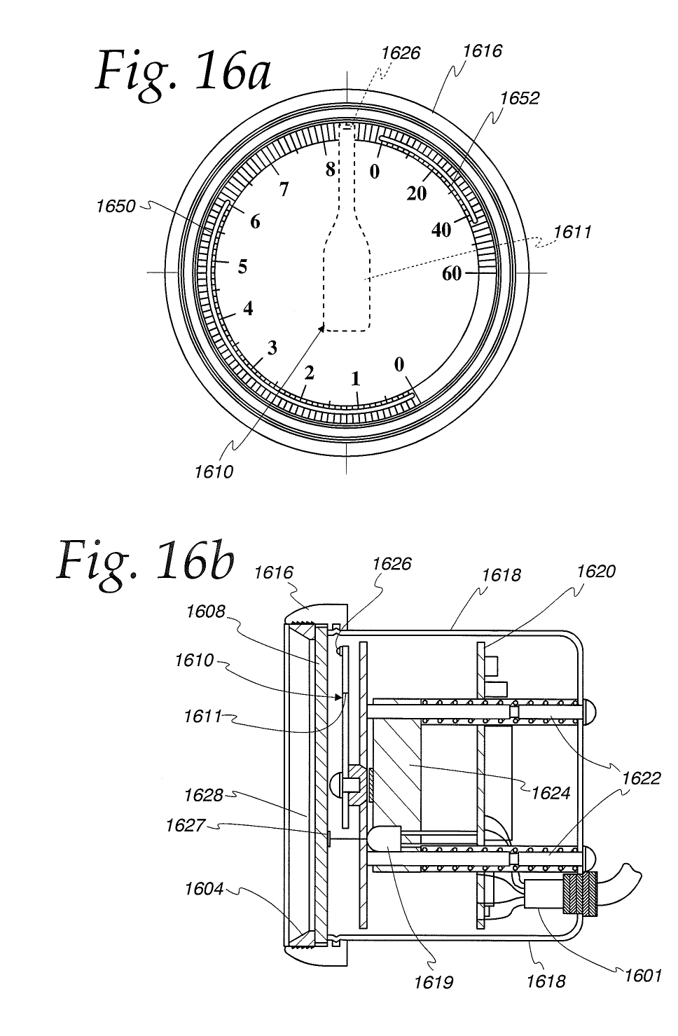

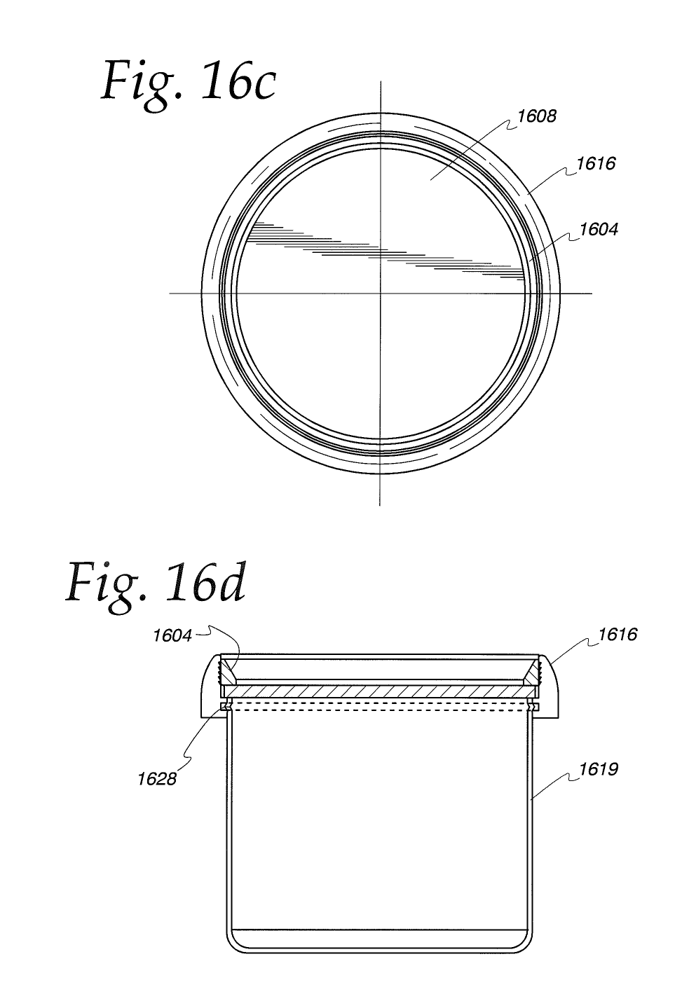

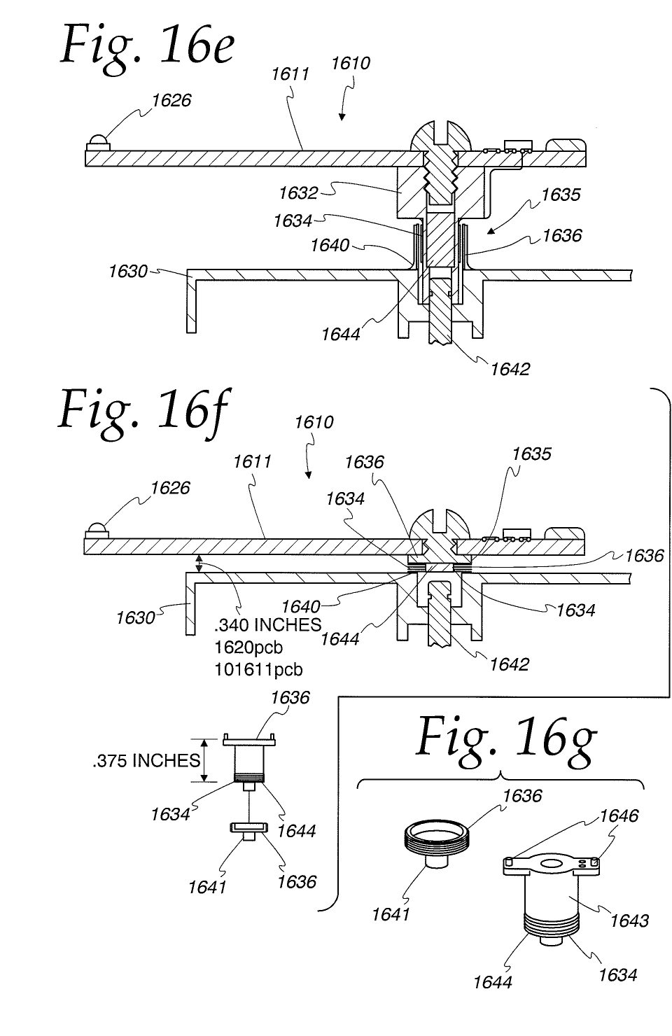

Referring collectively now to FIGS. 16a-g, diagrams illustrating the housing of the gauge are described. As shown, the gauge includes a housing 1618, which, in this example is an aluminum deep draw can. The housing 1618 contains a motor 1624, a rotary transformer 1635, and the shaft-mounted light pointer 1610. The light pointer 1610 includes a carrier member 1611 (e.g., a PCB) on which an LED 1626 is positioned. Circuit boards 1620 are also positioned in the housing 1618 and provide overall control and motor control functions for the gauge (e.g., they may be one of the circuit boards of FIGS. 4-8 and 10). In an alternative approach, the dual PCB circuit topology (one for the control board and one for a motor control board) could be exchanged for a single PCB using surface mount components and construction. External data sources and power are provided to the gauge components with a single multi-pin connector or wire harness.

As mentioned, the circuit boards 1620 provide overall control and motor control functions and are remotely located from the light pointer 1610. For example, the circuit boards 1620 boards may be any of control and motor boards described with respect to FIGS. 4-8 and FIG. 10 and the light pointer 1610 may include the circuit of FIG. 9. By remotely mounting the microcontroller portion of the gauge circuitry, the user may have easier access to the cylinder select switches, and the wiring for power input, signal input, and signal output wires.

The gauge includes a lens 1608, which may be backside printed with gauge indicia. The lens 1608 may be constructed from glass, plastic, or any other suitable material. Arcs of light 1650 and 1652 are displayed on the lens 1608. An aluminum front Bezel 1616 has a roller swaging at point 1628 on the assembly 1618. A ring 1604 of some suitable material (e.g., Delrin or Zytel) is pressed into the Bezel 1616 to retain the lens 1608 on the gauge.

The motor 1624 turns the light pointer 1610 at a constant rate of speed. The boards 1620, for example, provide power to the motor 1624 and process the motor synch signals and various input signals (received via the connector 1601). The boards process the signals to provide one or more arcs of light on the lens 1608.

Spacers 1622 are provided to provide spacing between components in the housing 1618. A motor shaft 1642 and shaft coupler 1632 couple the motor to the light pointerl610. As shown in FIG. 16e, a primary winding 1636 and secondary winding 1634 may be connected to outer motor housing 1630 by glue 1640. The primary winding 1636 (having a ferrite bead core 1644) is attached on the outside of the housing 1630 and the secondary winding 1634 has an inner winding attached at the shaft coupler 1632.

The shaft coupler 1632 comprises a secondary bobbin and magnetic core and is made from an insulating non-magnetic material such as nylon or Zytel. The shaft coupler 1632 has the light pointer carrier 1611 attached at one end. The secondary winding 1634 is wound directly on the shoulder below the carrier member 1611. The secondary winding 1634 (having a powder metal core or having a ferrite bead core 1644) is wound on the shaft coupler 1632. This carrier/shaft coupler assembly is press fitted to the end of the fan motor shaft passing through the primary core and positions the secondary winding 1634 within approximately 0.005-0.008 inch above the primary winding 1636 in this example. The secondary winding 1634 may be wound directly over the magnetic core and then may be surrounded by the outer primary winding 1636 mounted to the motor case. A touch switch area 1628 is positioned directly over the touch switch electrode 1627, which couples the touch switch electrode 1627 to the boards 1620. The touch switch area 1628 is touched to activate the touch switch electrode 1628 and the signal created is sensed at the one of the circuit boards 1620. An alarm LED 1619 is also coupled to one of the boards 1620.

Referring now to FIG. 16f, another example of an assembly is described wherein the distance between the light pointer 1610 and housing 1630 is reduced compared to the example of FIG. 16e by using smaller bobbins to secure the transformer elements to the light pointer 1610. In this example, the distance between the light pointer 1610 and the housing 1630 is approximately 0.340 inches.

Referring now to FIG. 16g, an example of a small and compact primary bobbin 1641 and a small and compact secondary bobbin 1643 are described. The primary bobbin 1641 has attached the primary windings 1636 and the secondary bobbin 1643 has the secondary windings 1634. The primary bobbin 1641 fits over the secondary bobbin 1643. Bobbin 1643 may include strain relief pins 1646 which align the bobbins to the pointer PCB. The primary and secondary bobbins 1641 and 1643 may be molded from Zytel plastic or any other suitable material for a precision fit part to the motor while providing a very close tolerance air gap between the secondary and primary windings.

In operation, the motor 1624 drives the light pointer 1610 in a circular motion around the face of the lens 1608. The boards 1620 receive signals from external informational sources (e.g., temperature sensors, pressure sensors, RPM sensors, and fuel level indicators), and this information is displayed as one or more arcs of light on the lens 1608 by activating the LED 1626 on the carrier member 1611.

It will be appreciated that the approaches shown in FIGS. 16a-g provide one example of a gauge whereby the light pointer 1610 rotates 360 degrees. Other structures are possible depending upon the application or needs of the user. Other approaches or mechanical structures may be used to implement the features and functions of the gauge or gauge components. In addition, for arcs of light displayed at different circumferences of the lens, multiple LEDs may be positioned on the carrier member 1611.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A system for displaying information on a gauge, the system comprising:
at least one measuring device operable to measure a quantity of a predetermined vehicle operating characteristic;
a light pointer for generating directed light;
a rotary drive for driving of the light pointer in a predetermined rotary path;
a controller coupled to the rotary drive and the measurement device, the controller being operable to selectively activate the light pointer as the light pointer is driven in the rotary path based upon input received from the measurement devices so that the light pointer generates at least one light arc corresponding to the measured quantity of the predetermined vehicle characteristic.

2. The system of claim 1 wherein the light pointer comprises a single light source.

3. The system of claim 2 wherein the single light source comprises an LED.

4. The system of claim 1 wherein the light pointer comprises a rotatable light pipe.

5. The system of claim 1 wherein the rotary drive comprises a rotary transformer and a brushless motor.

6. The system of claim 1 wherein the light arc comprises a first arc and a second arc and wherein the first arc and the second arc are displayed with a common base point.

7. The system of claim 1 wherein the at least one light arc comprises an arc selected from a group comprising: a solid arc, a flashing arc, a variable length arc, and a sweeping arc.

8. The system of claim 1 the at least one light arc comprise a plurality of light arcs and each of the light arcs is positioned and displayed so as to be non-overlapping from the others.

9. The system of claim 1 further comprising a touch sensitive switch coupled to the controller.

10. The system of claim 9 wherein the touch sensitive switch is adapted to change a display characteristic upon actuation, the display characteristic being selected from a group comprising: a cylinder count; a sensor calibration value; a low alarm value; a high alarm value; a peak display reset value; a distance traveled; a default configuration value; and a demonstration mode speed.

11. The system of claim 1 wherein the predetermined vehicle characteristics are selected from a group comprising an engine speed, an engine exhaust gas temperature, and an engine pressure.

12. The system of claim 1 further comprising a communication bus, the communication bus being communicatively coupled to the controller, and wherein the communication bus is adaptable to being coupled to a plurality of external electronic devices.

13. The system of claim 12 wherein the controller is adapted to receive commands from a personal computer over the communication bus.

14. The system of claim 1 wherein at least one of the plurality of measurement devices is an analog measurement device.

15. The system of claim 14 wherein the analog measurement device senses a quantity, the quantity being selected from a group comprising a voltage, a pressure, a resistance, a current, a temperature, a speed, a distance, and a vacuum value.

16. The system of claim 1 wherein at least one of the plurality of measuring devices comprises a thermocouple amplifier.

17. The system of claim 1 further comprising a voltage regulator circuit, the voltage regular circuit being adapted to selectively adjust an intensity of at least one element of the system, the at least one element selected from a group comprising: the light pointer; an alarm icon; and a backlight brightness.

18. The system of claim 17 wherein the voltage regulator circuit comprises a pulse width modulator (PWM) programmable linear adjustable voltage regulator.

19. A system for programming parameters of a vehicle display, the system comprising:
a display including at least one light source for displaying a level of a vehicle operating characteristic as a length of light displayed according to a predetermined format; and
a user interface device being programmed to adjust the predetermined format of the display.

20. The system of claim 19 wherein the predetermined format determines an arc characteristic selected from a group comprising: an arc beginning point; an arc ending point; a low alarm value; a high alarm value; a time slot select; a gauge type; a sensor minimum value; a sensor maximum value; an engineering unit; a conversion value; a decal minimum value; a decal maximum value; a minimum intensity value; a maximum intensity value; a slew rate; a sensor channel; a meter arc size; an arc direction; a software revision; and a cylinder count.

21. The system of claim 19 wherein the user interface device is a personal computer.

22. The system of claim 19 wherein the user interface device is adapted to present a menu of configuration options to a user.

23. The system of claim 19 further comprising an engine controller, the engine controller being coupled to the communication bus.

24. The system of claim 23 wherein the gauge is further programmed to exchange information with the engine controller via the communication bus.

25. The system of claim 19 further comprising at least one analog device coupled to the gauge.

26. The system of claim 19 wherein the at least one analog device provides information indicative of a quantity, the quantity being selected from a group comprising a voltage, a pressure, a resistance, a current, a temperature, a speed, a distance, and a vacuum value.

27. The system of claim 19 wherein the user interface is adaptable to program parameters into the gauge thereby configuring hardware parameters of the gauge.

28. A method of providing measurement information to a user, the method comprising:
receiving information indicating a quantity to be displayed;
activating a light pointer based upon the information received; and
rotating the light pointer with sufficient speed to generate an arc of light of a predetermined arcuate length to indicate a level of the quantity to be displayed.

29. The method of claim 28 wherein the light pointer is continuously rotated in a 360 degree path to generate the arc of light and the light pointer is activated during a portion of the travel of the light pointer in the 360 degree path.

30. The method of claim 28 further comprising determining a maximum value of the received information and displaying the maximum value to the user with the rotating light pointer.

31. The method of claim 28 further comprising determining a minimum value of the received information and displaying the minimum value to the user with the rotating light pointer.

32. The method of claim 28 wherein the receiving the information comprises receiving engine RPM data.

33. The method of claim 28 wherein the receiving the information comprises receiving air/fuel meter data.

34. The method of claim 28 further comprising determining and displaying both minimum and maximum peak values of the received information with the rotating light pointer.

35. The method of claim 28 wherein the information indicating a quantity to be displayed comprises information including at least one of voltage, pressure, resistance, current, temperature, speed, distance, and vacuum value.

36. A system comprising:
a light source;
a carrier member for the light source;
a rotary drive for the carrier member operable to shift the carrier member and the light source thereon in a predetermined arcuate path for generating at least one arc of light.

37. The system of claim 36 further comprising a controller, the controller programmed to display a vehicle operating characteristic as the at least one arc of light.

38. The system of claim 37 wherein the controller is programmed to selectively activate and deactivate the light source to create the at least one arc of light.

39. The system of claim 37 wherein the controller is programmed to activate and deactivate the light source so as to provide a single arc of light.

40. The system of claim 37 wherein the controller is programmed to activate and deactivate the light source so as to provide a multiple arcs of light.

41. The system of claim 37 further comprising a touch sensitive switch coupled to the controller.

42. The system of claim 41 wherein the touch sensitive switch is adapted to change a display characteristic upon actuation, the display characteristic being selected from a group comprising: a cylinder count; a sensor calibration value; a low alarm value;
a high alarm value; a peak display reset value; a distance traveled; a default configuration value; and a demonstration mode speed.

43. The system of claim 37 further comprising a communication bus, the communication bus being communicatively coupled to the controller, and wherein the communication bus is adaptable to being coupled to a plurality of external electronic devices.

44. The system of claim 43 wherein the controller is adapted to receive commands from a personal computer over the communication bus.

45. The system of claim 37 further comprising at least one measurement device coupled to the controller.

46. The system of claim 45 wherein the measurement device senses a quantity, the quantity being selected from a group comprising a voltage, a pressure, a resistance, a current, a temperature, a speed, a distance, and a vacuum value.

47. The system of claim 36 wherein the light source comprises a single light source.

48. The system of claim 47 wherein the single light source comprises an LED.

49. The system of claim 36 wherein the rotary drive comprises a rotary transformer and a brushless motor.

50. The system of claim 36 wherein the at least one light arc comprises a first arc and a second arc and wherein the first arc and the second arc are displayed with a common base point.

51. The system of claim 36 wherein the at least one light arc comprises an arc selected from a group comprising: a solid arc, a flashing arc, a variable length arc, and a sweeping arc.

52. The system of claim 36 the at least one light arc comprise a plurality of light arcs and each of the light arcs is positioned and displayed so as to be non-overlapping from the others.

53. The system of claim 36 wherein the at least one arc of like has a length associated with at least one vehicle operating characteristic.

54. The system of claim 53 wherein the at least one vehicle operating characteristic is selected from a group comprising an engine speed, an engine exhaust gas temperature, and an engine pressure.
